(19) United States
(12) Patent Application Publication
(10) Pub. No.: US 2025/0386187 A1
(43) Pub. Date: Dec. 18, 2025

(54) AUTHENTICATION METHOD

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 18/875,607

(22) PCT Filed: Jun. 17, 2022
(86) PCT No.: PCT/CN2022/099634

§ 371 Date: Dec. 16, 2024

(51) Int. Cl. H04W 12/06; H04W 12/0431

(52) U.S. Cl. CPC H04W 12/06; H04W 12/0431

(57) ABSTRACT

Embodiments of the present disclosure relate to an authentication method. A core network device performs EAP-AKA′ authentication on a PINE. The PINE is accessed to the first class network by means of a PEGC, and the PINE is connected to the PEGC by means of a second class network.

### CROSS-REFERENCE TO RELATED APPLICATIONS

The present application is a U.S. National Stage of International Application No. PCT/CN2022/099634 filed on Jun. 17, 2022, the entire contents of which are incorporated herein by reference for all purpose.

### TECHNICAL FIELD

The present disclosure relates to, but is not limited to, the field of wireless communication technology, and in particular, to an authentication method and device, communication device, and storage medium.

### BACKGROUND

A personal IoT network (PIN) refers to the internet of things (IoT) around personal and home scenarios. The PIN includes three types of devices (A.K.A PIN elements): a device with gateway capability such as a personal IoT network element with gateway capability (A.K.A PIN element with gateway capability, PEGC), a device with management capability (A.K.A PIN element with management capability, PEMC), and a device without gateway and management capabilities, such as personal IoT network element with gateway capability (PEGC) such as a personal IoT element (PIN element, PINE). The PEGC and PEMC are user equipments (UEs) that can directly access a 5^{th} generation system (5GS). The PEMC can also access the 5GS through the PEGC. However, the PINE cannot access the 5GS directly.

### SUMMARY

A first aspect of embodiments of the present disclosure provides an authentication method, which is performed by a core network device of a first class network, including:
performing extensible authentication protocol-authentication and key agreement′ (EAP-AKA′) authentication on a personal IoT network element (PINE), wherein the PINE is accessed to the first class network through a personal IoT network element with gateway capability (PEGC), and the PINE is connected to the PEGC through a second class network.

In an embodiment, performing the EAP-AKA′ authentication on the PINE includes:
determining an expected authentication parameter at least based on a calculating parameter and a first credential of the PINE; and
performing the authentication on the PINE at least based on the expected authentication parameter.

In an embodiment, the first credential is stored in the core network device.

In an embodiment, the first credential is determined by the core network device based on a PINE identifier of the PINE and/or a PEGC identifier of the PEGC.

In an embodiment, performing the EAP-AKA′ authentication on the PINE at least based on the expected authentication parameter includes:
sending an EAP request to the PEGC via a base station by means of the first class network, wherein the EAP request at least includes the calculating parameter, and the calculating parameter is sent through the EAP request to the PINE by means of a second class network;
receiving an EAP response sent by the PEGC via the base station by means of the first class network, wherein the EAP response at least includes an authentication parameter, and the authentication parameter is determined by the PINE at least based on a second credential and the calculating parameter and is carried in the EAP response to be sent to the PEGC by means of the second class network; and
performing the EAP-AKA′ authentication on the PINE at least based on a comparison of the authentication parameter and the expected authentication parameter.

In an embodiment, sending the EAP request to the PEGC via the base station by means of the first class network includes at least one of:
sending, by a unified data management (UDM) in the core network device, a UDM response carrying the EAP request to an authentication service function (AUSF) in the core network device;
sending, by the AUSF, an AUSF response carrying the EAP request to a security anchor function (SEAF) in the core network device; or
sending, by the SEAF, an authentication request carrying the EAP request to the PEGC via the base station by means of the first class network, wherein the EAP request is carried in a PINE authentication request by the PEGC to be sent to the PINE.

In an embodiment, receiving the EAP response sent by the PEGC via the base station by means of the first class network includes at least one of:
receiving, by the SEAF, an authentication response carrying the EAP response sent by the PEGC via the base station by means of the first class network, wherein the EAP response is carried in a PINE authentication response by the PINE to be sent to the PEGC by means of the second class network; or
receiving, by the AUSF, an AUSF authentication request carrying the EAP response sent by the SEAF.

In an embodiment, at least one of the UDM response, the AUSF response, the authentication request, the authentication response, the PINE authentication request, the PINE authentication response or the AUSF authentication request carries at least one of:
a PINE authentication indicator indicating to perform the EAP-AKA′ authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

In an embodiment, the method further includes: in response to the PINE identifier being a protected PINE identifier, restoring the protected PINE identifier to a PINE identifier in a plaintext state,
wherein at least one of the UDM response, the AUSF response, or the AUSF authentication request carries the PINE identifier in the plaintext state, and at least one of the authentication request, the PINE authentication request, the PINE authentication response, or the authentication response carries the protected PINE identifier.

In an embodiment, the PINE authentication indicator indicates the core network device and the PINE not to perform at least one of:
generating an authentication service function key Kausf;
generating a security anchor function key Kseaf;
sending a key set identifier ngKSI to the PEGC; or
sending an anti-bidding down between architectures (ABBA) parameter to the PEGC.

In an embodiment, the authentication parameter and the expected authentication parameter are identified using at least one of:

a PINE identifier of the PINE; or
a PEGC identifier of the PEGC.

In an embodiment, the method further includes:
determining a first integrity protection key and a first confidentiality protection key at least based on a first service network name and the first credential of the PINE,
wherein the EAP request is protected by the first integrity protection key and the first confidentiality protection key.

In an embodiment, the EAP request further includes first indication information configured to determine the first service network name.

In an embodiment, the method further includes: determining, based on judging information, whether the PEGC is a legitimate gateway for the PEGC to access the first class network, wherein the judging information includes at least one of:
a PEGC identifier of the PEGC;
a PINE identifier of the PINE; or
subscription information of the PEGC, and
wherein determining the expected authentication parameter at least based on the calculating parameter and the first credential of the PINE includes:
determining the PEGC as the legitimate gateway; and
determining the expected authentication parameters based on the calculating parameter and the first credential of the PINE.

In an embodiment, the first credential is determined by a UDM in the core network device based on a PINE identifier of the PINE and/or a PEGC identifier of the PEGC.

In an embodiment, the first class network includes a 3^{rd} generation partnership project (3GPP) standard network, and
the second class network includes a non-3GPP standard network.

In an embodiment, a second aspect of embodiments of the present disclosure provides an authentication method, which is performed by a personal IoT network element with gateway capability (PEGC), including:
communicating authentication information during a core network device of a first class network performing extensible authentication protocol-authentication and key agreement′ (EAP-AKA′) authentication on a personal IoT network element (PINE), wherein the PINE is accessed to the first class network through the PEGC, and the PINE is connected to the PEGC through a second class network.

In an embodiment, communicating the authentication information during the core network device of the first class network performing the EAP-AKA′ authentication on the PINE includes:
receiving an EAP request carrying a calculating parameter sent by the core network device to the PEGC via a base station by means of the first class network, wherein the calculating parameter is configured for the core network device to determine an expected authentication parameter at least in conjunction with a first credential, and the expected authentication parameter is configured for the core network device to perform the authentication on the PINE.

In an embodiment, the first credential is determined by the core network device based on a PINE identifier of the PINE and/or a PEGC identifier of the PEGC.

In an embodiment, communicating the authentication information during the core network device of the first class network performing the EAP-AKA′ authentication on the PINE includes:
sending the EAP request carrying the calculating parameter to the PINE by means of the second class network;
receiving an EAP response carrying an authentication parameter sent by the PINE by means of the second class network, wherein the authentication parameter is determined by the PINE at least based on a second credential and the calculating parameter; and
sending the EAP response carrying the authentication parameter to the core network device via the base station by means of the first class network, wherein the authentication parameter is configured for the core network device to perform the authentication on the PINE at least based on the expected authentication parameter.

In an embodiment, receiving the EAP request carrying the calculating parameter sent by the core network device to the PEGC via the base station by means of the first class network includes:
receiving an authentication request carrying the EAP request sent by an SEAF in the core network device via the base station by means of the first class network,
sending the EAP request carrying the calculating parameter to the PINE by means of the second class network includes:
   sending a PINE authentication request carrying the EAP request to the PINE by means of the second class network,
   receiving the EAP response carrying the authentication parameter sent by the PINE by means of the second class network includes:
   receiving a PINE authentication response carrying the EAP response sent by the PINE by means of the second class network, and
   sending the EAP response carrying the authentication parameter to the core network device via the base station by means of the first class network includes:
   sending an authentication response carrying the EAP response to the SEAF via the base station by means of the first class network.

In an embodiment, at least one of the authentication request, the authentication response, the PINE authentication request or the PINE authentication response carries at least one of:
a PINE authentication indicator indicating to perform the authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

In an embodiment, the PINE authentication indicator indicates the core network device and the PINE not to perform at least one of:
generating an authentication service function key Kausf;
generating a security anchor function key Kseaf;
sending a key set identifier ngKSI to the PEGC; or
sending an anti-bidding down between architectures (ABBA) parameter to the PEGC.

In an embodiment, the EAP request further includes first indication information configured to determine a first service network name.

In an embodiment, the method further includes:
sending second indication information indicating a second service network name to the PINE.

A third aspect of embodiments of the present disclosure provides an authentication method, which is performed by a personal IoT network element (PINE), including:
communicating authentication information during a core network device of a first class network performing extensible authentication protocol-authentication and key agreement′ (EAP-AKA′) authentication on the PINE, wherein the PINE is accessed to the first class network through a personal IoT network element with gateway capability (PEGC), and the PINE is connected to the PEGC through a second class network.

In an embodiment, communicating the authentication information during the core network device of the first class network performing the EAP-AKA′ authentication on the PINE includes:
receiving an EAP request carrying a calculating parameter sent by the PEGC by means of the second class network, wherein the EAP request is sent by the core network device to the PEGC via a base station by means of the first class network, the calculating parameter is configured for the core network device to determine an expected authentication parameter at least in conjunction with a first credential, and the expected authentication parameter is configured for the core network device to perform the authentication on the PINE.

In an embodiment, the first credential is determined by the core network device based on a PINE identifier of the PINE and/or a PEGC identifier of the PEGC.

In an embodiment, the method further includes: determining an authentication parameter at least based on a second credential and the calculating parameter,
wherein communicating the authentication information during the core network device of the first class network performing the authentication on the PINE includes:
sending an EAP response carrying the authentication parameter to the PEGC by means of the second class network, the EAP response being sent to the core network device by the PEGC via the base station by means of the first class network and configured for the core network device to perform the authentication on the PINE at least based on the authentication parameter and the expected authentication parameter.

In an embodiment, receiving the EAP request carrying the calculating parameter sent by the PEGC by means of the second class network includes:
receiving a PINE authentication request carrying the EAP request sent by the PEGC by means of the second class network, and
sending the EAP response carrying the authentication parameter to the PEGC by means of the second class network includes:
sending a PINE authentication response carrying the EAP response to the PEGC by means of the second class network.

In an embodiment, the PINE authentication request and/or the PINE authentication response carries at least one of:
a PINE authentication indicator indicating to perform the authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

In an embodiment, the PINE authentication indicator indicates the core network device and the PINE not to perform at least one of:
generating an authentication service function key Kausf;
generating a security anchor function key Kseaf;
sending a key set identifier ngKSI to the PEGC; or
sending an anti-bidding down between architectures (ABBA) parameter to the PEGC.

In an embodiment, the EAP request further includes first indication information configured to determine a first service network name.

In an embodiment, the method further includes:
determining a second integrity protection key and a second confidentiality protection key at least based on the first service network name and a second credential; and
verifying the EAP request using the second integrity protection key and the second confidentiality protection key.

In an embodiment, the method further includes:
in response to that verifying the EAP request fails, sending verifying failure information to the core network device to stop performing the EAP-AKA′ authentication on the PINE.

In an embodiment, the method further includes:
receiving second indication information indicating a second service network name sent by the PEGC; and
in response to that verifying the EAP request is successful, verifying a consistency between the first service network name and the second service network name.

A fourth aspect of embodiments of the present disclosure provides an authentication device, including:
a processing module, configured to perform extensible authentication protocol-authentication and key agreement′ (EAP-AKA′) authentication on a personal IoT network element (PINE), wherein the PINE is accessed to the first class network through a personal IoT network element with gateway capability (PEGC), and the PINE is connected to the PEGC through a second class network.

In an embodiment, the processing module is specifically configured to:
determine an expected authentication parameter at least based on a calculating parameter and a first credential of the PINE; and
perform the authentication on the PINE at least based on the expected authentication parameter.

In an embodiment, the first credential is stored in the core network device.

In an embodiment, the first credential is determined by the core network device based on a PINE identifier of the PINE and/or a PEGC identifier of the PEGC.

In an embodiment, the device further includes:
a transceiver module, configured to send an EAP request to the PEGC via a base station by means of the first class network, wherein the EAP request at least includes the calculating parameter, and the calculating parameter is sent through the EAP request to the PINE by means of a second class network;
the transceiver module is further configured to receive an EAP response sent by the PEGC via the base station by means of the first class network, wherein the EAP response at least includes an authentication parameter, and the authentication parameter is determined by the PINE at least based on a second credential and the calculating parameter and is carried in the EAP response to be sent to the PEGC by means of the second class network; and
the processing module is specifically configured to perform the EAP-AKA′ authentication on the PINE at least based on a comparison of the authentication parameter and the expected authentication parameter.

In an embodiment, the transceiver module is specifically configured to perform at least one of:
sending, by a unified data management (UDM) in the core network device, a UDM response carrying the EAP request to an authentication service function (AUSF) in the core network device;
sending, by the AUSF, an AUSF response carrying the EAP request to a security anchor function (SEAF) in the core network device; or
sending, by the SEAF, an authentication request carrying the EAP request to the PEGC via the base station by means of the first class network, wherein the EAP request is carried in a PINE authentication request by the PEGC to be sent to the PINE.

In an embodiment, the transceiver module is specifically configured to perform at least one of:
receiving, by the SEAF, an authentication response carrying the EAP response sent by the PEGC via the base station by means of the first class network, wherein the EAP response is carried in a PINE authentication response by the PINE to be sent to the PEGC by means of the second class network; or
receiving, by the AUSF, an AUSF authentication request carrying the EAP response sent by the SEAF.

In an embodiment, at least one of the UDM response, the AUSF response, the authentication request, the authentication response, the PINE authentication request, the PINE authentication response or the AUSF authentication request carries at least one of:
a PINE authentication indicator indicating to perform the EAP-AKA′ authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

In an embodiment, the processing module is further configured to, in response to the PINE identifier being a protected PINE identifier, restore the protected PINE identifier to a PINE identifier in a plaintext state,
wherein at least one of the UDM response, the AUSF response, or the AUSF authentication request carries the PINE identifier in the plaintext state, and
at least one of the authentication request, the PINE authentication request, the PINE authentication response, or the authentication response carries the protected PINE identifier.

In an embodiment, the PINE authentication indicator indicates the core network device and the PINE not to perform at least one of:
generating an authentication service function key Kausf;
generating a security anchor function key Kseaf;
sending a key set identifier ngKSI to the PEGC; or
sending an anti-bidding down between architectures (ABBA) parameter to the PEGC.

In an embodiment, the authentication parameter and the expected authentication parameter are identified using at least one of:
a PINE identifier of the PINE; or
a PEGC identifier of the PEGC.

In an embodiment, the processing module is further configured to
determine a first integrity protection key and a first confidentiality protection key at least based on a first service network name and the first credential of the PINE,
wherein the EAP request is protected by the first integrity protection key and the first confidentiality protection key.

In an embodiment, the EAP request further includes first indication information configured to determine the first service network name.

In an embodiment, the processing module is further configured to determine, based on judging information, whether the PEGC is a legitimate gateway for the PEGC to access the first class network, wherein the judging information includes at least one of:
a PEGC identifier of the PEGC;
a PINE identifier of the PINE; or
subscription information of the PEGC, and
wherein determining the expected authentication parameter at least based on the calculating parameter and the first credential of the PINE includes:
determining the PEGC as the legitimate gateway; and
determining the expected authentication parameters based on the calculating parameter and the first credential of the PINE.

In an embodiment, the first credential is determined by a UDM in the core network device based on a PINE identifier of the PINE and/or a PEGC identifier of the PEGC.

In an embodiment, the first class network includes a 3rd generation partnership project (3GPP) standard network, and
the second class network includes a non-3GPP standard network.

A fifth aspect of embodiments of the present disclosure provides an authentication device, including:
a transceiver module, configured to communicate authentication information during a core network device of a first class network performing extensible authentication protocol-authentication and key agreement′ (EAP-AKA′) authentication on a personal IoT network element (PINE), wherein the PINE is accessed to the first class network through the PEGC, and the PINE is connected to the PEGC through a second class network.

In an embodiment, the transceiver module is specifically configured to:
receive an EAP request carrying a calculating parameter sent by the core network device to the PEGC via a base station by means of the first class network, wherein the calculating parameter is configured for the core network device to determine an expected authentication parameter at least in conjunction with a first credential, and the expected authentication parameter is configured for the core network device to perform the authentication on the PINE.

In an embodiment, the first credential is determined by the core network device based on a PINE identifier of the PINE and/or a PEGC identifier of the PEGC.

In an embodiment, the transceiver module is specifically configured to:
send the EAP request carrying the calculating parameter to the PINE by means of the second class network;
receive an EAP response carrying an authentication parameter sent by the PINE by means of the second class network, wherein the authentication parameter is determined by the PINE at least based on a second credential and the calculating parameter; and
send the EAP response carrying the authentication parameter to the core network device via the base station by means of the first class network, wherein the authentication parameter is configured for the core network device to perform the authentication on the PINE at least based on the expected authentication parameter.

In an embodiment, the transceiver module is specifically configured to perform at least one of:
receiving an authentication request carrying the EAP request sent by an SEAF in the core network device via the base station by means of the first class network,
sending a PINE authentication request carrying the EAP request to the PINE by means of the second class network,
receiving a PINE authentication response carrying the EAP response sent by the PINE by means of the second class network, or
sending an authentication response carrying the EAP response to the SEAF via the base station by means of the first class network.

In an embodiment, wherein at least one of the authentication request, the authentication response, the PINE authentication request or the PINE authentication response carries at least one of:
a PINE authentication indicator indicating to perform the authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

In an embodiment, the PINE authentication indicator indicates the core network device and the PINE not to perform at least one of:
generating an authentication service function key Kausf;
generating a security anchor function key Kseaf;
sending a key set identifier ngKSI to the PEGC; or
sending an anti-bidding down between architectures (ABBA) parameter to the PEGC.

In an embodiment, the EAP request further includes first indication information configured to determine a first service network name.

In an embodiment, the transceiver module is further configured to:
send second indication information indicating a second service network name to the PINE.

A sixth aspect of embodiments of the present disclosure provides an authentication device, including:
a transceiver module, configured to communicate authentication information during a core network device of a first class network performing extensible authentication protocol-authentication and key agreement′ (EAP-AKA′) authentication on the PINE, wherein the PINE is accessed to the first class network through a personal IoT network element with gateway capability (PEGC), and the PINE is connected to the PEGC through a second class network.

In an embodiment, the transceiver module is specifically configured to:
receive an EAP request carrying a calculating parameter sent by the PEGC by means of the second class network, wherein the EAP request is sent by the core network device to the PEGC via a base station by means of the first class network, the calculating parameter is configured for the core network device to determine an expected authentication parameter at least in conjunction with a first credential, and the expected authentication parameter is configured for the core network device to perform the authentication on the PINE.

In an embodiment, the first credential is determined by the core network device based on a PINE identifier of the PINE and/or a PEGC identifier of the PEGC.

In an embodiment, the device further includes:
a processing module, configured to determine an authentication parameter at least based on a second credential and the calculating parameter,
the transceiver module is specifically configured to:
send an EAP response carrying the authentication parameter to the PEGC by means of the second class network, the EAP response being sent to the core network device by the PEGC via the base station by means of the first class network and configured for the core network device to perform the authentication on the PINE at least based on the authentication parameter and the expected authentication parameter.

In an embodiment, the transceiver module is specifically configured to perform at least one of:
receiving a PINE authentication request carrying the EAP request sent by the PEGC by means of the second class network, or
sending a PINE authentication response carrying the EAP response to the PEGC by means of the second class network.

In an embodiment, the PINE authentication request and/or the PINE authentication response carries at least one of:
a PINE authentication indicator indicating to perform the authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

In an embodiment, the PINE authentication indicator indicates the core network device and the PINE not to perform at least one of:
generating an authentication service function key Kausf; generating a security anchor function key Kseaf;
sending a key set identifier ngKSI to the PEGC; or
sending an anti-bidding down between architectures (ABBA) parameter to the PEGC.

In an embodiment, the EAP request further includes first indication information configured to determine a first service network name.

In an embodiment, the device further includes a processing module, configured to:
determine a second integrity protection key and a second confidentiality protection key at least based on the first service network name and a second credential; and
verifying the EAP request using the second integrity protection key and the second confidentiality protection key.

In an embodiment, the processing module is further configured to:
in response to that verifying the EAP request fails, send verifying failure information to the core network device to stop performing the EAP-AKA′ authentication on the PINE.

In an embodiment, the transceiver module is further configured to receive second indication information indicating a second service network name sent by the PEGC; and
the processing module is further configured to, in response to that verifying the EAP request is successful, verify a consistency between the first service network name and the second service network name.

A seventh aspect of embodiments of the present disclosure provides a communication device apparatus including a processor, a memory and an executable program stored on the memory and runnable by the processor, wherein the processor, when running the executable program, implements steps in the authentication method according to the first or second or third aspect.

An eighth aspect of embodiments of the present disclosure provides a storage medium having stored thereon an executable program that, when being executed by a processor, implements steps in the authentication method according to the first or second or third aspect.

### BRIEF DESCRIPTION OF THE DRAWINGS

The accompanying drawings herein, which are incorporated into and form a part of the specification, illustrate the principle according to embodiments of the present disclosure, and serve, in conjunction with the specification, to explain the embodiments of the present disclosure.

FIG. 1 is a schematic structure diagram of a wireless communication system according to an embodiment;

FIG. 2 is a flowchart of an authentication method according to an embodiment;

FIG. 3 is a flowchart of a method of triggering a core network device to perform authentication according to an embodiment;

FIG. 4 is a flowchart of an authentication method according to an embodiment;

FIG. 5 is a flowchart of an authentication method according to an embodiment;

FIG. 6 is a flowchart of an authentication method according to an embodiment;

FIG. 7 is a flowchart of an authentication method according to an embodiment;

FIG. 8 is a flowchart of an authentication method according to an embodiment;

FIG. 9 is a flowchart of an authentication method according to an embodiment;

FIG. 10 is a flowchart of an authentication method according to an embodiment;

FIG. 11 is a flowchart of an authentication method according to an embodiment;

FIG. 12 is a flowchart of an authentication method according to an embodiment;

FIG. 13 is a flowchart of an authentication interaction according to an embodiment;

FIG. 14 is a block diagram of an authentication device according to an embodiment;

FIG. 15 is a block diagram of an authentication device according to an embodiment;

FIG. 16 is a block diagram of an authentication device according to an embodiment; and

FIG. 17 is a block diagram of a device for authentication according to an embodiment.

### DETAILED DESCRIPTION

Embodiments will be described herein in detail, examples of which are represented in the accompanying drawings. When the following description relates to the accompanying drawings, the same numerals in the different figures indicate the same or similar elements unless otherwise indicated. The implementations described in the following embodiments do not represent all implementations consistent with the embodiments of the present disclosure. Rather, they are only examples of devices and methods consistent with some aspects of embodiments of the present disclosure as detailed in the appended claims.

The term used in the embodiments of the present disclosure is used solely for the purpose of describing particular embodiments and is not intended to limit the present disclosure. The singular forms of “a”, “said” and “the” used in the embodiments of the present disclosure and the appended claims are also intended to encompass the plural forms, unless clearly indicated otherwise in the context. It is to be also understood that the term “and/or” as used herein refers to and encompasses any or all possible combinations of one or more of the associated listed items.

It is to be understood that while the terms first, second, third, etc. may be used in the embodiments of the present disclosure to describe various types of information, such information should not be limited to these terms. These terms are only used to distinguish the same type of information from one another. For example, without departing from the scope of the embodiments of the present disclosure, first information may also be referred to as second information, and similarly, the second information may be referred to as the first information. Depending on the context, the word “if” as used herein may be interpreted as “at the time of . . . ” or “when . . . ” or “in response to determining”.

Referring to FIG. 1, a schematic structure diagram of a wireless communication system provided by an embodiment of the present disclosure is illustrated. As shown in FIG. 1, the wireless communication system is a communication system based on cellular mobile communication technology, and the wireless communication system may include a plurality of terminals 11 and a plurality of base stations 12.

The terminal 11 may be a device that provides voice and/or data connectivity to a user. The terminal 11 may communicate with one or more core network devices via a radio access network (RAN). The terminal 11 may be an IoT terminal, such as sensor device, mobile phone (or so-called ‘cellular’ phone), and computer with a IoT terminal, which may be, for example, fixed, portable, pocket-sized, handheld, computer-integrated, or vehicle-mounted device, for example, a station (STA), a subscriber unit, a subscriber station, a mobile station, a mobile, a remote station, an access point, a remote terminal, an access terminal, a user terminal, a user agent, a user device or a user equipment (UE). Alternatively, the UE may be an unmanned aerial vehicle device. Alternatively, the UE may be an in-vehicle device, e.g., it may be a trip computer with a wireless communication capability, or a wireless communication device externally connected to a trip computer. Alternatively, the UE may be a roadside device, e.g., it may be a street light, a signal light, or other roadside devices having a wireless communication capability.

The base station 12 may be a network-side device in the wireless communication system. The wireless communication system may be the 4^{th} generation mobile communication system, also known as a long term evolution (LTE) system, or may be a 5G system, also known as a new radio (NR) system or 5G NR system. Alternatively, the wireless communication system may be a further next generation system of the 5G system. The access network in the 5G system may be called NG-RAN (new generation-radio access network). Alternatively, the wireless communication system may be an MTC system.

The base station 12 may be an evolved base station (eNB) used in the 4G system. Alternatively, the base station 12 may be a base station (gNB) of a centralized distributed architecture used in the 5G system. When the base station 12 uses the centralized distributed architecture, it typically includes a central unit (CU) and at least two distributed units (DUs). The central unit is provided with a protocol stack of packet data convergence protocol (PDCP) layer, radio link control (RLC) layer, and media access control (MAC) layer, and the distributed unit is provided with a protocol stack of physical (PHY) layer. The specific implementation of the base station 12 is not limited in the embodiments of the present disclosure.

A wireless connection may be established between the base station 12 and the terminal 11 via a wireless radio. In various implementations, the wireless radio is a wireless radio based on the 4^{th} generation mobile communication network technology (4G) standard; alternatively, the wireless radio is a wireless radio based on the 5^{th} generation mobile communication network technology (5G) standard, for example, the wireless radio is the new radio; alternatively, the wireless radio may be a wireless radio based on a further next generation mobile communication network technology standard based on the 5G.

In some embodiments, an E2E (End to End) connection may also be established between the terminals 11, examples of which include V2V (vehicle to vehicle) communication, V2I (vehicle to infrastructure) communication, and V2P (vehicle to pedestrian) communication in a vehicle to everything (V2X) scenario or the like.

In some embodiments, the wireless communication system described above may further include a network management device 13.

A number of base stations 12 are each connected to the network management device 13. The network management device 13 may be a core network device in the wireless communication system. For example, the network management device 13 may be a mobility management entity (MME) in the evolved packet core (EPC). Alternatively, the network management device may be other core network device such as a serving gateway (SGW), a public data network gateway (PGW), a policy and charging rules function Unit (PCRF), or a home subscriber server (HSS). The implementation form of the network management device 13 is not limited in the embodiments of the present disclosure.

A PINE cannot directly access a cellular mobile communication network, such as a 5GS network. How to make the PINE directly access the cellular mobile communication network is an urgent problem to be solved.

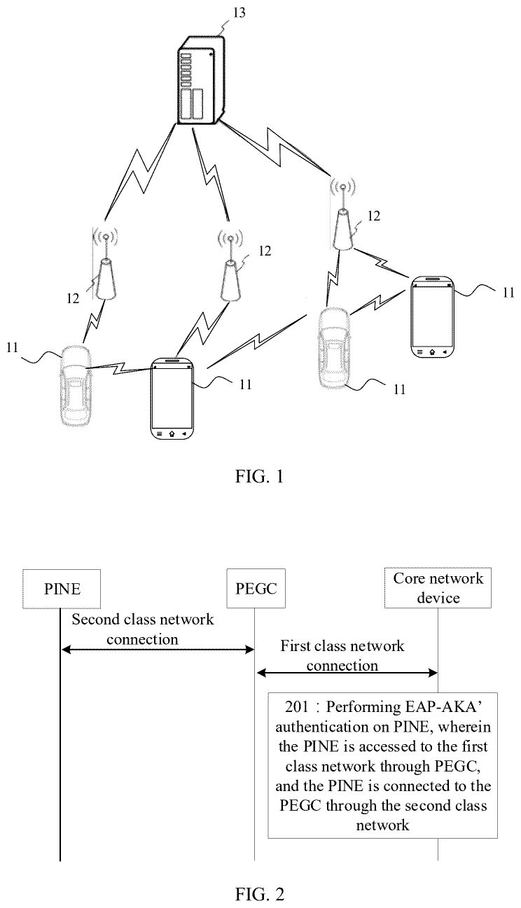

As shown in FIG. 2, the embodiment provides an authentication method that can be performed by a core network device of a cellular mobile communication system, which includes:
step 201, performing EAP-AKA′ authentication on a PINE, wherein the PINE is accessed to a first class network through a PEGC, and the PINE is connected to the PEGC through a second class network.

In an embodiment, the first class network includes a 3^{rd} generation partnership project (3GPP) standard network, and the second class network includes a non-3GPP standard network.

Here, the first class network may be a cellular mobile communication network meeting the 3GPP standard, such as a 5GS network. The second class network may be a non-3GPP standard network, and the second class network includes, but is not limited to, at least one of a Wi-Fi network, a Bluetooth network, a ZigBee network, or the like.

Here, the PINE may be a communication device in the IoT that may not directly access the first class network (e.g., a cellular mobile communication network such as 5GS), for example, the PINE may be a wearable device, a smart home appliance, a smart office device, or the like. The PEGC may be a communication device that can directly access the first class network (e.g., a cellular mobile communication network). The PEGC may have the capability of accessing both the first class network and the second class network. The PEGC may provide a communication device (e.g., a PINE) that may not directly access the first class network (e.g., a cellular mobile communication network) with a gateway service for accessing the first class network. The PEGC and the communication device that may not directly access the first class network may be connected via the second class network.

In an embodiment, the PEGC includes a user equipment (UE).

The PEGC may be a UE having the capability of accessing both the first class network and the second class network, for example, the PEGC may be a terminal device such as a mobile phone.

The PINE may access the 5GS via the PEGC, and the 5GS identifies the PINE for enhanced management. For example, the 5GS may determine the Quality of Service (QOS) for different PINEs and so on. Therefore, the core network device may perform authentication on the PINE.

Here, the EAP-AKA′ authentication on the PINE may be performed by the core network device. The PINE and the core network device may transmit to each other authentication information that needs to be transmitted during the authentication. Here the authentication information may include a PINE identifier, a root key or the like.

The EAP-AKA′ may be used for bidirectional authentication between the core network device and the PINE.

After performing the EAP-AKA′ authentication on the PINE, the core network device may implement 3GPP-compliant management for the PINE, for example, may adopt corresponding QoS and security policies for data transmission of the PINE or the like.

In this way, the EAP-AKA′ authentication on the PINE is performed by the core network device, so that the PINE may directly access the cellular mobile communication network, and the communication of the PINE within the first class network may be managed by the core network device to satisfy the management requirements of the core network device for the devices accessing the first class network, which satisfies data transmission requirements of the PINE and improves the reliability of data transmission.

In a possible implementation, the cellular mobile communication network provides the PINE with a credential. With the credential, the cellular mobile communication network may verify and identify the PINE connected to the PEGC.

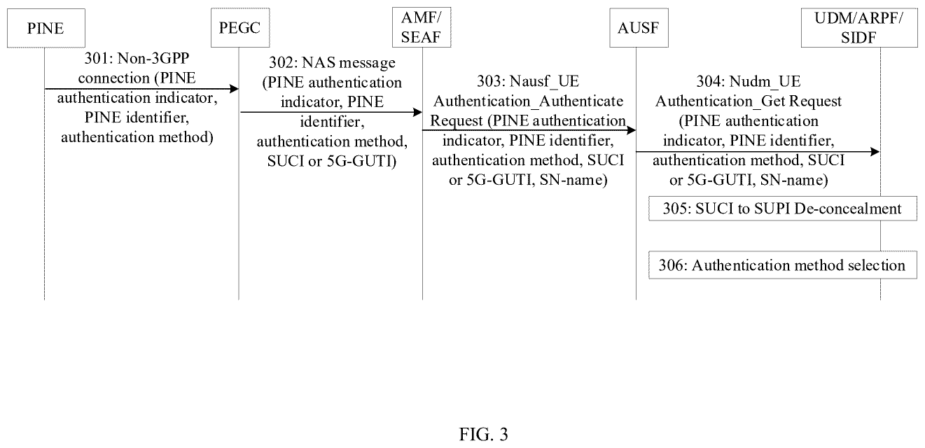

In a possible implementation, the authentication on the PINE may be triggered by the PINE, the PEGC and/or the core network device. The EAP-AKA′ authentication on the PINE is triggered, and as shown in FIG. 3, the PINE triggers the core network device to trigger the authentication on the PINE, which may include the followings.

In step 301, the PINE sends a PINE identifier thereof (i.e., a device identifier of the PINE) to the PEGC over a non-3GPP connection (the second class network), and at the same time, sends an authentication method and a PINE authentication indicator. The non-3GPP connection (the second class network) established between the PINE and the PEGC may be a secure connection. How to establish the non-3GPP secure link is not limited here.

In step 302, the PEGC sends, via a NAS message, the PINE authentication indicator, the PINE identifier, the authentication method, an SUCI of the PEGC or a 5G-GUTI to an AMF/SEAF network element in the core network device.

In step 303, whenever the AMF wishes to initiate the PINE, the AMF may invoke a Nausf_UE Authentication service by sending a Nausf_UE Authentication_Authenticate Request message to the AUSF. The Nausf_UE Authentication_Authenticate Request message may contain the PINE authentication indicator, the PINE identifier, the authentication method, and a service network name (SN-Name).

In step 304, after receiving the Nausf_UE Authentication_Authenticate Request message, the AUSF may check, by comparing the service network name (SN-Name) with an expected service network name (SN-Name), whether the requesting AMF in the service network is authorized to use the service network name in the Nausf_UE Authentication_Authenticate Request message. The AUSF may temporarily store the received service network name. If the service network is not authorized to use the service network name, the AUSF responds in the Nausf_UE Authentication_Authenticate Response with “service network not authorized”. If the service network is authorized to use the service network name, the AUSF sends, to the UDM, a Nudm_UE Authentication_Get Request message, which may include the PINE authentication indicator, the PINE identifier, the SUPI or SUCI of the PEGC, the authentication method, and the service network name.

In step 305, if the UDM receives the SUCI after receiving the Nudm_UE Authentication_Get Request, the UDM may invoke a subscription identifier de-concealing function (SIDF) to decrypt the SUCI to obtain the SUPI.

In step 306, the UDM/ARPF allows the PEGC to perform the authentication on the PINE according to the SUPI and the device identifier of the PEGC and based on the subscription verification of the PEGC, and then selects the authentication method for the PINE based on the PINE identifier and the authentication method sent by the PINE.

In the above method, the PINE may locally store the credential provided by the home network of the PEGC (i.e., the second class network). The PINE identifier of the PINE may be associated with the subscription information of the PEGC. The PEGC may be a gateway that has been registered into the 5GC, and the connection between the PEGC and the AMF is secured by the NAS. The AMF is juxtaposed with the SEAF.

In an embodiment, performing the EAP-AKA′ authentication on the personal IoT element (PINE) includes:
determining an expected authentication parameter at least based on a calculating parameter and a first credential of the PINE; and
performing the authentication on the PINE at least based on the expected authentication parameter.

In the embodiment, the expected authentication parameter may be represented as XRES, and the authentication parameter may be represented as RES.

The PINE credential configured for the PINE by the first network may include a first credential stored in the core network device and a second credential stored in the PINE. For the same PINE, the first credential is identical to the second credential. The PINE credential may be used as a root key for EAP-AKA′ authentication on the PINE.

In a possible implementation, the PINE credential may be configured by the first network for the PINE. Different PINE credentials may correspond to different PINEs.

In an embodiment, the first credential is stored in the core network device.

In a possible implementation, the first credential is stored in the UDM.

In an embodiment, the first credential is determined by the core network device based on the PINE identifier of the PINE and/or the PEGC identifier of the PEGC.

In a possible implementation, the first credential may correspond to the PINE identifier of the PINE. Here, the PINE identifier may include a protected PINE identifier or a plaintext PINE identifier. The protected PINE identifier may include one of an anonymized PINE identifier or an encrypted PINE identifier.

In a possible implementation, the first credential may correspond to the PINE identifier of the PINE and/or the PEGC identifier of the PEGC for the PINE. The PINE identifier may uniquely identify the PINE, and the PEGC identifier may uniquely identify the PEGC.

The core network device may determine the first credential corresponding to the PINE based on the PINE identifier of the PINE and/or the PEGC identifier. Here, the PINE identifier may be carried by trigger information that triggers the core network device to perform the authentication on the PINE. For example, the trigger information may be Nudm_UE Authentication_Get Request or the like.

The core network device may determine the XRES based on at least the first credential and the calculating parameter.

The calculating parameter may be at least one parameter employed in the process of calculating the XRES. Here, the calculating manner employed by the core network device to determine the XRES may be the same as the calculating manner employed by the PINE to determine the RES.

In an embodiment, the calculating parameter includes at least a random number RAND.

The calculating parameter may be a random number used to calculate the XRES.

The core network device may send the calculating parameter to the PINE, which determines the RES in conjunction with the stored second credential. The PINE may determine the RES based on a similar method as described above, which is not repeated herein.

In an embodiment, the first credential is determined by the UDM in the core network device based on the PINE identifier of the PINE and/or the PEGC identifier of the PEGC.

The trigger information for triggering the authentication on the PINE may be sent to the UDM. The UDM may determine the first credential of the PINE based on the PINE identifier and/or the PEGC identifier of the PEGC.

The first credential may be stored in the UDM, and the XRES may be determined by the UDM, which in turn initiates the authentication on the PINE.

The XRES may be used to compare with the RES calculated by the PINE, thereby determining whether the second credential of the PINE or the like is identical to the first credential or the like in the UDM, thereby determining the identifier of the PINE and completing the authentication on the PINE. The UDM may include an authentication credential repository and processing function (ARPF).

For example, for each Nudm_Authenticate_Get Request shown in FIG. 3, the UDM/ARPF creates a 5G HE AV for the PINE based on the locally stored PINE credential, i.e., the first credential, which may be achieved by the UDM/ARPF generating an AV with an authentication management field (AMF) separation bit set to be “1”. The UDM/ARPF may then calculate the XRES. The UDM/ARPF may create an AV′, which may include: a RAND, an authentication token (AUTN), and an XRES.

In a possible implementation, the AV′ may also include an integrity key CK′ and an encryption key IK′. The CK′ and IK′ may also be determined based on the first credential and the calculating parameter. The CK′ and IK′ may be sent to the PINE along with the calculating parameter.

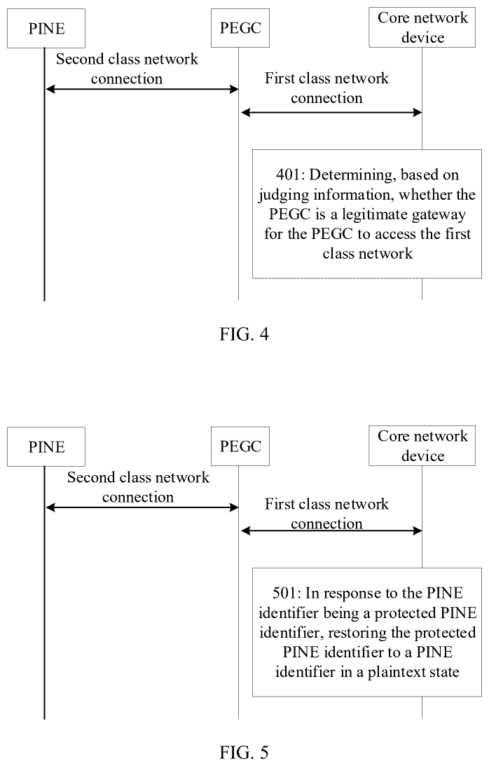

As shown in FIG. 4, the embodiment provides an authentication method, which may be performed by a core network device of a cellular mobile communication system, including: step 401, determining, based on judging information, whether the PEGC is a legitimate gateway for the PEGC to access the first class network, wherein the judging information includes at least one of:
the PEGC identifier of the PEGC;
the PINE identifier of the PINE; or
subscription information of the PEGC, and
determining the expected authentication parameter at least based on the calculating parameter and the first credential of the PINE comprises:
determining the PEGC as the legitimate gateway; and
determining the expected authentication parameters based on the calculating parameter and the first credential of the PINE.

Step 401 may be implemented alone or in combination with step 201.

Before the UDM determines the XRES, the UDM may also determine whether the PEGC is a legitimate gateway for the PINE. The UDM may first determine whether the PEGC is a legitimate gateway in the first class network based on the judging information. For example, the UDM may make a judgement based on the PEGC identifier. The UDM may then determine whether the PEGC is a legitimate gateway for the PINE, for example, it may determine whether the PEGC is allowed to access the PINE into the first class network. The UDM may make the judgement based on the PEGC identifier, the PINE identifier of the PINE, and the subscription information of the PEGC. For example, when the subscription information of the PEGC identified by the PEGC identifier has the PINE identifier of the PINE, the PEGC is determined to be the legitimate gateway for the PINE.

The PEGC identifier may include a subscription concealed identifier (SUCI) and/or a subscription permanent identifier (SUPI).

In an embodiment, performing the EAP-AKA′ authentication on the PINE at least based on the expected authentication parameter includes:
sending an EAP request to the PEGC via a base station by means of the first class network, wherein the EAP request at least includes the calculating parameter, and the calculating parameter is sent through the EAP request to the PINE by means of a second class network;
receiving an EAP response sent by the PEGC via the base station by means of the first class network, wherein the EAP response at least includes an authentication parameter, and the authentication parameter is determined by the PINE at least based on a second credential and the calculating parameter and is carried in the EAP response to be sent to the PEGC by means of the second class network; and
performing the EAP-AKA′ authentication on the PINE at least based on a comparison of the authentication parameter and the expected authentication parameter.

The core network device, after determining the XRES, may send the EAP request to the PEGC for the PINE via the second class network. The EAP request may include the calculating parameter. Here the EAP request may be sent by the PEGC to the PINE for the PINE to determine the RES based on the second credential, the calculating parameter or the like. The second credential may be determined by the first network, e.g., may be determined by the core network device of the first network, and may be sent by the first network to the PINE via the PEGC.

In a possible implementation, the EAP request may further include information for the EAP-AKA′ authentication such as CK′ and IK′, which will not be repeated herein.

The EAP request may be an EAP-Request/AKA′-Challenge.

The core network device may determine whether the EAP-AKA′ authentication on the PINE is successful at least based on a comparison between RES and XRES.

The calculating method used by the core network to determine XRES and the calculating method used by the PINE to determine RES may be the same. In the case where the calculating methods are the same, if the calculating parameters or the like used in the calculating process are the same, XRES and RES are the same, and if the calculating parameters or the like used in the calculating process are different, XRES and RES are different.

If the first credential is the same as the second credential, then the RES and ERES determined based on the same calculating parameter are also the same, and thus the PINE authentication is successful.

If the first credential is not the same as the second credential, then the RES and ERES determined based on the same calculating parameter are not the same either, and thus the PINE authentication fails.

In an embodiment, sending the EAP request to the PEGC via the base station by means of the first class network includes at least one of:
sending, by a unified data management (UDM) in the core network device, a UDM response carrying the EAP request to an authentication service function (AUSF) in the core network device;
sending, by the AUSF, an AUSF response carrying the EAP request to a security anchor function (SEAF) in the core network device; or
sending, by the SEAF, an authentication request carrying the EAP request to the PEGC via the base station by means of the first class network, wherein the EAP request is carried in a PINE authentication request by the PEGC to be sent to the PINE.

The UDM may carry the calculating parameter (e.g., RAND) in the UDM response to be sent to the AUSF. The UDM response may be a Nudm_UE Authentication_Get Response. For example, the UDM may return AV′ in the Nudm_UE Authentication_Get Response to the AUSF. The AV′ may include RAND, AUTN, and XRES. The UDM response may carry a PINE authentication indicator indicating to perform the authentication on the PINE. The AUSF may determine, based on the PINE authentication indicator, that the UDM response is used to perform the EAP-AKA′ authentication on the PINE.

If the PINE identifier and the SUCI of the PEGI are included in the Nudm_UE Authentication_Get Request, the UDM may include the PINE identifier and the SUCI of the PEGI in the Nudm_UEAuthentication_Get Response after de-concealment of the SUCI by the SIDF.

The AUSF may store the XRES, PINE identifier, and SUPI.

The AUSF may return the EAP request (which may contain RAND and AUTN), the PINE authentication indicator, the SUPI of the PEGC, and the PINE identifier to the SEAF in the AUSF response (e.g., Nausf_UE Authentication_Authenticate Response).

The SEAF may send, to the PEGC, the PINE authentication indicator, EAP request (containing RAND, AUTN), and PINE identifier in the authentication request (e.g., a NAS message). The authentication request may be an Authentication Request.

The PEGC may forward the EAP request (containing RAND, AUTN) and the PINE authentication indicator received in the authentication request to the PINE via a secure non-3GPP second network. The PEGC may also receive the SN-Name in the PINE authentication request.

The PINE receives the RAND and AUTN carried in the received PINE authentication request. The PINE may determine whether the PINE authentication request is acceptable by checking the AUTN. For example, the PINE may verify the freshness of the received AUTN. If the PINE determines that the PINE authentication request is acceptable, the PINE may calculate the RES, for example, the PINE may first calculate the RES, CK, IK, and then the PINE ME may obtain the RES through the RES calculation.

In an embodiment, receiving the EAP response sent by the PEGC via the base station by means of the first class network includes at least one of:
receiving, by the SEAF, an authentication response carrying the EAP response sent by the PEGC via the base station by means of the first class network, wherein the EAP response is carried in a PINE authentication response by the PINE to be sent to the PEGC by means of the second class network; or
receiving, by the AUSF, an AUSF authentication request carrying the EAP response sent by the SEAF.

After determining the RES, the PINE may send the RES to the core network device.

The PINE may return the PINE authentication response to the PEGC over the secure second class network of non-3GPP, and the PINE authentication response may include the EAP response, PINE Identifier, and PINE authentication indicator. The PINE authentication response may be a PINE Authentication Response. The EAP response carries the RES determined by the PINE.

The EAP response may be EAP-Response/AKA′-Challenge.

The PEGC may send the authentication response to the SEAF via the NAS message, and the authentication response may include the EAP response, PINE identifier and PINE authentication indicator. The authentication response may be an Authentication Response.

The SEAF may send the EAP response, PINE identifier, PINE authentication indicator and SUPI of the PEGI to the AUSF in the AUSF authentication request (Nausf_UE Authentication_Authenticate Request).

The AUSF performs the authentication on the PINE based on the authentication parameter and the expected authentication parameter.

When receiving the AUSF authentication request (Nausf_UE Authentication_Authenticate Request message) including the EAP response (containing RES) as the authentication confirmation, the AUSF may verify whether the maintained XRES has expired. If the XRES has expired, the AUSF may determine that the PINE authentication is unsuccessful. The AUSF may compare the received RES with the stored XRES. If the RES and XRES are equal, the AUSF may consider from the perspective of a home network that the authentication is successful.

The AUSF may indicate to the SEAF in the AUSF authentication response (Nausf_UEAuthentication_Authenticate Response) whether the PINE authentication is successful from the perspective of the home network.

In a possible implementation, in response to the AUSF determining that the authentication is successful, the AUSF may send an EAP success message to the SEAF in the Nausf_UE Authentication_Authenticate Response, and the SEAF may transparently forward the EAP success to the PEGC. If the AUSF receives a SUCI from the SEAF at the time of initiating the authentication (see subclause 6.1.2 of this document), the AUSF may also include the SUCI in the Nausf_UE Authentication_Authenticate Response message. The Nausf_UE Authentication Authenticate Response message contains the PINE authentication indicator and the decrypted PINE identifier.

For lawful interception, the AUSF sending SUPI to SEAF is necessary but not sufficient. By including the SUPI as input parameter to the key derivation of KAMF from KSEAF, additional assurance on the correctness of SUPI is achieved by the service network from both the home network and UE side.

In a possible implementation, in response to the SEAF receiving the EAP success message, the SEAF may send the EAP success message to the PEGC via an N1 message. The message also includes the PINE authentication indicator and the decrypted PINE identifier.

In a possible implementation, in response to the PEGC receiving the EAP success message, the PEGC sends the EAP success message and the PINE authentication indicator to the PINE over a secure non-3GPP connection.

The AUSF may indicate to the SEAF in the AUSF authentication response (Nausf_UE Authentication_Authenticate Response) whether or not the PINE authentication is successful from the perspective of the home network.

In an embodiment, the authentication parameter and the expected authentication parameter are identified using at least one of:
a PINE identifier of the PINE; or
a PEGC identifier of the PEGC.

In a possible implementation, the RES and XRES may each have a PINE identifier that is used respectively to indicate a corresponding PINE, and/or a PEGC identifier that indicates a corresponding PEGC. When storing the RES and/or XRES, the core network device may identify the same with the PINE identifier and/or PEGC identifier. For example, the AUSF may employ the PINE identifier when storing RES and/or XRES.

In a possible implementation, during the transmission of RES and XRES, it may be identified by using the PINE identifier and/or the PEGC identifier carried by a transmission message. The transmission message may include at least one of the UDM response, the AUSF response, the authentication request, the authentication response, the PINE authentication request, the PINE authentication response, or the AUSF authentication request.

In an embodiment, at least one of the UDM response, the AUSF response, the authentication request, the authentication response, the PINE authentication request, the PINE authentication response, and the AUSF authentication request carries at least one of: a PINE authentication indicator indicating to perform the EAP-AKA′ authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

Here, the PINE authentication indicator may indicate, to the core network device (e.g., UDM, AUSF and SEAF), the PEGC and the PINE, that the received message is used for the PINE authentication.

The SUPI may indicate, to the core network device (e.g., UDM, AUSF and SEAF), the PEGC and the PINE, the PEGC to which the PINE to be authenticated is connected. The core network device and/or the PINE may send corresponding information to the PEGC indicated by the SUPI.

Here, the PINE identifier may indicate, to the core network device and the PEGC, the PINE to be authenticated.

In a possible implementation, the PINE identifier is a protected PINE identifier.

The protected PINE identifier may include an encrypted PINE identifier, an anonymous PINE identifier, or the like.

In a possible implementation, at least one of the UDM response, the AUSF response, the authentication request, the PINE authentication request, the PINE authentication response, the authentication response, or the AUSF authentication request carries the protected PINE identifier.

As shown in FIG. 5, the embodiment provides an authentication method, which may be performed by a core network device of a cellular mobile communication system, including: step 501, in response to the PINE identifier being a protected PINE identifier, restoring the protected PINE identifier to a PINE identifier in a plaintext state.

At least one of the UDM response, the AUSF response, or the AUSF authentication request carries the PINE identifier in the plaintext state.

At least one of the authentication request, the PINE authentication request, the PINE authentication response, or the authentication response carries the protected PINE identifier.

Step 501 may be implemented alone or in combination with step 201 and/or step 401.

When a network element of the core network device (e.g., UDM) receives a PINE identifier as a protected PINE identifier, it transforms the protected PINE identifier into a PINE identifier in a plaintext state by using a de-anonymizing manner, a decrypting manner and so on.

The PINE identifier in plaintext state may be used by the core network device during the transmission of the protected PINE identifier within the core network device. For example, at least one of the authentication request, the PINE authentication request, the PINE authentication response, or the authentication response carries the protected PINE identifier.

The protected PINE identifier may be used when the PINE identifier is communicated outside the core network device. That is, the protected PINE identifier is used in the communication between the three of SEAF, PEGC and PINE, for example, at least one of the authentication request, the PINE authentication request, the PINE authentication response, or the authentication response carries the protected PINE identifier.

In a possible implementation, if the PINE identifier received by the UDM is unprotected information (i.e., the PINE identifier in the plaintext state), the unprotected information (the PINE identifier in plaintext state) is used in the communication between the three of SEAF, PEGC and PINE. For example, at least one of the authentication request, the PINE authentication request, the PINE authentication response or the authentication response carries the PINE identifier in the plaintext state.

In an embodiment, the PINE authentication indicator indicates the core network device and the PINE not to perform at least one of:
generating an authentication service function key Kausf;
generating a security anchor function key Kseaf;
sending a key set identifier ngKSI to the PEGC; or
sending an anti-bidding down between architectures (ABBA) parameter to the PEGC.

In the related art, the UDM determines the Kausf during the authentication process. Here, the UDM may neither determine nor communicate the Kausf during the PINE authentication process, thereby reducing the load on the core network device. The authentication service function key KAUSF generates the security anchor function key KSEAF.

In the related art, the AUSF determines the Kseaf during the authentication process. Here, the AUSF may neither determine the Kseaf nor communicate the Kseaf during the PINE authentication process, thereby reducing the load of the core network device. The key set identifier ngKSI is an identifier of a key set used by the UE in the first class network, and is used to indicate that the first class network uses the same key set as the UE. The ABBA parameter is used for the AMF network element to generate the KAMF. The key set identifier (ngKSI, a key set identifier in 5G) may be used for the creation of the native security context if the authentication is successful. The anti-bidding down between architectures (ABBA) parameter prevents obfuscation of differentiated version security feature indication parameters.

Since the PINE accesses the first class network via the PEGC. Therefore, the SEAF may neither determine nor communicate the ngKSI and ABBA parameter, thereby reducing the load of the core network device.

In an embodiment, the method further includes: determining a first integrity protection key and a first confidentiality protection key at least based on a first service network name and the first credential of the PINE.

The EAP request is protected by the first integrity protection key and the first confidentiality protection key.

In a possible implementation, the AUSF may determine the first integrity protection key CK′ and the first confidentiality protection key IK′ for the EAP request based on the first credential and the first service network name. The first integrity protection key may be used for integrity protection of the EAP request, and the first confidentiality protection key may be used for confidentiality protection of the EAP request.

In an embodiment, the EAP request further includes first indication information configured to determine the first service network name.

The first indication information for determining the first service network name (SN-name) may be carried in the EAP request to be sent to the UE.

The first indication information may be used to indicate the first service network name, or the first indication information may be calculated at least with the first service network name by using a predetermined algorithm. With the first indication information, the UE may restore the first service network name.

For example, the first indication information may include a message authentication code (MAC) in the authentication token AUTN.

In a possible implementation, the PINE determines a second integrity protection key and a second confidentiality protection key at least based on the first service network name and a second credential.

The PINE employs the second integrity protection key and the second confidentiality protection key to verify the EAP request.

The PINE determines the first service network name corresponding to the PINE based on the first indication information.

In a possible implementation, the PINE may derive the second integrity protection key and the second confidentiality protection key at least based on the first service network name and the second credential.

The PINE may verify the EAP request based on the second integrity protection key and the second confidentiality protection key, for example, performing integrity verification and confidentiality verification.

In a possible implementation, in response to that verifying the EAP request fails, the PINE sends verifying failure information to the core network device to stop performing the EAP-AKA′ authentication on the PINE.

If the verification is successful, the EAP-AKA′ authentication process continues. Otherwise, the verifying failure information is sent to the core network device to stop performing the EAP-AKA′ authentication on the PINE. The PINE may discard the EAP request.

In a possible implementation, the PINE receives second indication information indicating a second service network name sent by the PEGC.

In response to that verifying the EAP request is successful, the PINE verifies a consistency between the first service network name and the second service network name.

The PINE determines the second service network name corresponding to the PINE based on the second indication information received from the PEGC.

In a possible implementation, the second indication information is carried in the authentication request sent by the PEGC to the PINE.

The second service network name (SN-name) is used to indicate the service network of the PINE.

After the EPA request is verified successfully using the second integrity protection key and the second confidentiality protection key, the PINE may also verify the consistency of the first service network name and the second service network name. If the first service network name and the second service network name are consistent, the EAP-AKA′ authentication process continues. Otherwise, the EAP-AKA′ authentication process is stopped.

In a possible implementation, in response to determining that the first service network name and the second service network name are not consistent, the PINE may generate local warming information, and continue sending the EAP response to the core network.

In a possible implementation, in response to determining that the first service network name and the second service network name are not consistent, the PINE may send error information to the core network to terminate the authentication process.

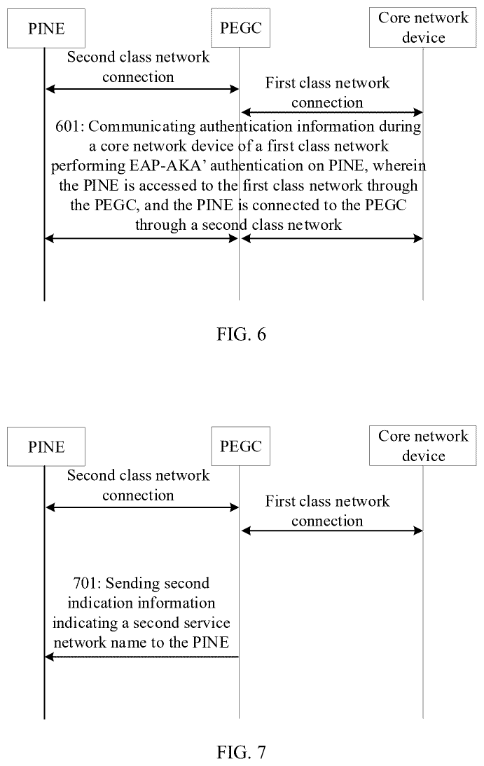

As shown in FIG. 6, the embodiment provides an authentication method that may be performed by a personal IoT network element with gateway capability (PEGC) of a cellular mobile communication system, including:

step 601, communicating authentication information during a core network device of a first class network performing EAP-AKA′ authentication on a PINE, wherein the PINE is accessed to the first class network through the PEGC, and the PINE is connected to the PEGC through a second class network.

In an embodiment, the first class network includes a 3rd generation partnership project (3GPP) standard network, and the second class network includes a non-3GPP standard network.

Here, the first class network may be a cellular mobile communication network meeting the 3GPP standard, such as a 5GS network. The second class network may be a non-3GPP standard network, and the second class network includes, but is not limited to, at least one of a Wi-Fi network, a Bluetooth network, a ZigBee network, or the like.

Here, the PINE may be a communication device in the IoT that may not directly access the first class network (e.g., a cellular mobile communication network such as 5GS), for example, the PINE may be a wearable device, a smart home appliance, a smart office device, or the like. The PEGC may be a communication device that can directly access the first class network (e.g., a cellular mobile communication network). The PEGC may have the capability of accessing both the first class network and the second class network. The PEGC may provide a communication device (e.g., a PINE) that may not directly access the first class network (e.g., a cellular mobile communication network) with a gateway service for accessing the first class network. The PEGC and the communication device that may not directly access the first class network may be connected via the second class network.

In an embodiment, the PEGC includes a user equipment (UE).

The PEGC may be a UE having the capability of accessing both the first class network and the second class network, for example, the PEGC may be a terminal device such as a mobile phone.

The PINE may access the 5GS via the PEGC, and the 5GS identifies the PINE for enhanced management. For example, the 5GS may determine the Quality of Service (QOS) for different PINEs and so on. Therefore, the core network device may perform authentication on the PINE.

Here, the EAP-AKA′ authentication on the PINE may be performed by the core network device. The PINE and the core network device may transmit to each other authentication information that needs to be transmitted during the authentication. Here the authentication information may include a PINE identifier, a root key or the like.

The EAP-AKA′ may be used for bidirectional authentication between the core network device and the PINE.

After performing the EAP-AKA′ authentication on the PINE, the core network device may implement 3GPP-compliant management for the PINE, for example, may adopt corresponding QoS and security policies for data transmission of the PINE or the like.

In this way, the EAP-AKA′ authentication on the PINE is performed by the core network device, so that the PINE may directly access the cellular mobile communication network, and the communication of the PINE within the first class network may be managed by the core network device to satisfy the management requirements of the core network device for the devices accessing the first class network, which satisfies data transmission requirements of the PINE and improves the reliability of data transmission.

In a possible implementation, the cellular mobile communication network provides the PINE with a credential. With the credential, the cellular mobile communication network may verify and identify the PINE connected to the PEGC.

In a possible implementation, the authentication on the PINE may be triggered by the PINE, the PEGC and/or the core network device. The EAP-AKA′ authentication on the PINE is triggered, and as shown in FIG. 3, the PINE triggers the core network device to trigger the authentication on the PINE, which may include the followings.

In step 301, the PINE sends a PINE identifier thereof (i.e., a device identifier of the PINE) to the PEGC over a non-3GPP connection (the second class network), and at the same time, sends an authentication method and a PINE authentication indicator. The non-3GPP connection (the second class network) established between the PINE and the PEGC may be a secure connection. How to establish the non-3GPP secure link is not limited here.

In step 302, the PEGC sends, via a NAS message, the PINE authentication indicator, the PINE identifier, the authentication method, an SUCI of the PEGC or a 5G-GUTI to an AMF/SEAF network element in the core network device.

In step 303, whenever the AMF wishes to initiate the PINE, the AMF may invoke a Nausf_UE Authentication service by sending a Nausf_UE Authentication_Authenticate Request message to the AUSF. The Nausf_UE Authentication_Authenticate Request message may contain the PINE authentication indicator, the PINE identifier, the authentication method, and a service network name (SN-Name).

In step 304, after receiving the Nausf_UE Authentication_Authenticate Request message, the AUSF may check, by comparing the service network name (SN-Name) with an expected service network name (SN-Name), whether the requesting AMF in the service network is authorized to use the service network name in the Nausf_UE Authentication_Authenticate Request. The AUSF may temporarily store the received service network name. If the service network is not authorized to use the service network name, the AUSF responds in the Nausf_UE Authentication_Authenticate Response with “service network not authorized”. If the service network is authorized to use the service network name, the AUSF sends, to the UDM, a Nudm_UE Authentication_Get Request message, which may include the PINE authentication indicator, the PINE identifier, the SUPI or SUCI of the PEGC, the authentication method, and the service network name.

In step 305, if the UDM receives the SUCI after receiving the Nudm_UE Authentication_Get Request, the UDM may invoke a subscription identifier de-concealing function (SIDF) to decrypt the SUCI to obtain the SUPI.

In step 306, the UDM/ARPF allows the PEGC to perform the authentication on the PINE according to the SUPI and the device identifier of the PEGC and based on the subscription verification of the PEGC, and then selects the authentication method for the PINE based on the PINE identifier and the authentication method sent by the PINE.

In the above method, the PINE may locally store the credential provided by the home network of the PEGC (i.e., the second class network). The PINE identifier of the PINE may be associated with the subscription information of the PEGC. The PEGC may be a gateway that has been registered into the 5GC, and the connection between the PEGC and the AMF is secured by the NAS. The AMF is juxtaposed with the SEAF.

In an embodiment, communicating the authentication information during the core network device of the first class network performing the EAP-AKA′ authentication on the PINE includes:
receiving an EAP request carrying a calculating parameter sent by the core network device to the PEGC via a base station by means of the first class network, wherein the calculating parameter is configured for the core network device to determine an expected authentication parameter at least in conjunction with a first credential, and the expected authentication parameter is configured for the core network device to perform the authentication on the PINE.

In the embodiment, the expected authentication parameter may be represented as XRES, and the authentication parameter may be represented as RES.

The PINE credential configured for the PINE by the first network may include a first credential stored in the core network device and a second credential stored in the PINE. For the same PINE, the first credential is identical to the second credential. The PINE credential may be used as a root key for EAP-AKA′ authentication on the PINE.

In a possible implementation, the PINE credential may be configured by the first network for the PINE. Different PINE credentials may correspond to different PINEs.

In an embodiment, the first credential is stored in the core network device.

In a possible implementation, the first credential is stored in the UDM.

In an embodiment, the first credential is determined by the core network device based on the PINE identifier of the PINE and/or the PEGC identifier of the PEGC.

In a possible implementation, the first credential may correspond to the PINE identifier of the PINE. Here, the PINE identifier may include a protected PINE identifier or a plaintext PINE identifier. The protected PINE identifier may include one of an anonymized PINE identifier or an encrypted PINE identifier.

In a possible implementation, the first credential may correspond to the PINE identifier of the PINE and/or the PEGC identifier of the PEGC for the PINE. The PINE identifier may uniquely identify the PINE, and the PEGC identifier may uniquely identify the PEGC.

The core network device may determine the first credential corresponding to the PINE based on the PINE identifier of the PINE and/or the PEGC identifier. Here, the PINE identifier may be carried by trigger information that triggers the core network device to perform the authentication on the PINE. For example, the trigger information may be Nudm_UE Authentication_Get Request or the like.

The core network device may determine the XRES based on at least the first credential and the calculating parameter.

The calculating parameter may be at least one parameter employed in the process of calculating the XRES. Here, the calculating manner employed by the core network device to determine the XRES may be the same as the calculating manner employed by the PINE to determine the RES.

In an embodiment, the calculating parameter includes at least a random number RAND.

The calculating parameter may be a random number used to calculate the XRES.

The core network device may send the calculating parameter to the PINE, which determines the RES in conjunction with the stored second credential. The PINE may determine the RES based on a similar method as described above, which is not repeated herein.

In an embodiment, the first credential is determined by the UDM in the core network device based on the PINE identifier of the PINE and/or the PEGC identifier of the PEGC.

The trigger information for triggering the authentication on the PINE may be sent to the UDM. The UDM may determine the first credential of the PINE based on the PINE identifier and/or the PEGC identifier of the PEGC.

The first credential may be stored in the UDM, and the XRES may be determined by the UDM, which in turn initiates the authentication on the PINE.

The XRES may be used to compare with the RES calculated by the PINE, thereby determining whether the second credential of the PINE or the like is identical to the first credential or the like in the UDM, thereby determining the identifier of the PINE and completing the authentication on the PINE. The UDM may include an authentication credential repository and processing function (ARPF).

For example, for each Nudm_Authenticate_Get Request shown in FIG. 3, the UDM/ARPF creates a 5G HE AV for the PINE based on the locally stored PINE credential, i.e., the first credential, which may be achieved by the UDM/ARPF generating an AV with an authentication management field (AMF) separation bit set to be “1”. The UDM/ARPF may then calculate the XRES. The UDM/ARPF may create an AV′, which may include: a RAND, an authentication token (AUTN), and an XRES.

In a possible implementation, the AV′ may also include an integrity key CK′ and an encryption key IK′. The CK′ and IK′ may also be determined based on the first credential and the calculating parameter. The CK′ and IK′ may be sent to the PINE along with the calculating parameter.

In a possible implementation, the core network device such as UDM determines, based on judging information, whether the PEGC is a legitimate gateway for the PEGC to access the first class network, wherein the judging information includes at least one of:
the PEGC identifier of the PEGC;
the PINE identifier of the PINE; or
subscription information of the PEGC.

The core network device determines that the PEGC is the legitimate gateway, and determines the expected authentication parameter based on the calculating parameter and the first credential of the PINE.

Before the UDM determines the XRES, the UDM may also determine whether the PEGC is a legitimate gateway for the PINE. The UDM may first determine whether the PEGC is a legitimate gateway in the first class network based on the judging information. For example, the UDM may make a judgement based on the PEGC identifier. The UDM may then determine whether the PEGC is a legitimate gateway for the PINE, for example, it may determine whether the PEGC is allowed to access the PINE into the first class network. The UDM may make the judgement based on the PEGC identifier, the PINE identifier of the PINE, and the subscription information of the PEGC. For example, when the subscription information of the PEGC identified by the PEGC identifier has the PINE identifier of the PINE, the PEGC is determined to be the legitimate gateway for the PINE.

The PEGC identifier may include a subscription concealed identifier (SUCI) and/or a subscription permanent identifier (SUPI).

In an embodiment, communicating the authentication information during the core network device of the first class network performing the EAP-AKA′ authentication on the PINE includes:
sending the EAP request carrying the calculating parameter to the PINE by means of the second class network;
receiving an EAP response carrying an authentication parameter sent by the PINE by means of the second class network, wherein the authentication parameter is determined by the PINE at least based on a second credential and the calculating parameter; and
sending the EAP response carrying the authentication parameter to the core network device via the base station by means of the first class network, wherein the authentication parameter is configured for the core network device to perform the authentication on the PINE at least based on the expected authentication parameter.

The core network device, after determining the XRES, may send the EAP request to the PEGC for the PINE via the second class network. The EAP request may include the calculating parameter. Here the EAP request may be sent by the PEGC to the PINE for the PINE to determine the RES based on the second credential, the calculating parameter or the like. The second credential may be determined by the first network, e.g., may be determined by the core network device of the first network, and may be sent by the first network to the PINE via the PEGC.

In a possible implementation, the EAP request may further include information for the EAP-AKA′ authentication such as CK′ and IK′, which will not be repeated herein.

The EAP request may be an EAP-Request/AKA′-Challenge.

The core network device may determine whether the EAP-AKA′ authentication on the PINE is successful at least based on a comparison between RES and XRES.

The calculating method used by the core network to determine XRES and the calculating method used by the PINE to determine RES may be the same. In the case where the calculating methods are the same, if the calculating parameters or the like used in the calculating process are the same, XRES and RES are the same, and if the calculating parameters or the like used in the calculating process are different, XRES and RES are different.

If the first credential is the same as the second credential, then the RES and ERES determined based on the same calculating parameter are also the same, and thus the PINE authentication is successful.

If the first credential is not the same as the second credential, then the RES and ERES determined based on the same calculating parameter are not the same either, and thus the PINE authentication fails.

In an embodiment, receiving the EAP request carrying the calculating parameter sent by the core network device to the PEGC via the base station by means of the first class network includes:
receiving an authentication request carrying the EAP request sent by an SEAF in the core network device via the base station by means of the first class network,
sending the EAP request carrying the calculating parameter to the PINE by means of the second class network includes:
sending a PINE authentication request carrying the EAP request to the PINE by means of the second class network,
receiving the EAP response carrying the authentication parameter sent by the PINE by means of the second class network includes:
receiving a PINE authentication response carrying the EAP response sent by the PINE by means of the second class network, and
sending the EAP response carrying the authentication parameter to the core network device via the base station by means of the first class network includes:
sending an authentication response carrying the EAP response to the SEAF via the base station by means of the first class network.

The UDM may carry the calculating parameter (e.g., RAND) in the UDM response to be sent to the AUSF. The UDM response may be a Nudm_UE Authentication_Get Response. For example, the UDM may return AV′ in the Nudm_UE Authentication_Get Response to the AUSF. The AV′ may include RAND, AUTN, and XRES. The UDM response may carry a PINE authentication indicator indicating to perform the authentication on the PINE. The AUSF may determine, based on the PINE authentication indicator, that the UDM response is used to perform the EAP-AKA′ authentication on the PINE.

If the PINE identifier and the SUCI of the PEGI are included in the Nudm_UE Authentication_Get Request, the UDM may include the PINE identifier and the SUCI of the PEGI in the Nudm_UEAuthentication_Get Response after de-concealment of the SUCI by the SIDF.

The AUSF may store the XRES, PINE identifier, and SUPI.

The AUSF may return the EAP request (which may contain RAND and AUTN), the PINE authentication indicator, the SUPI of the PEGC, and the PINE identifier to the SEAF in the AUSF response (e.g., Nausf_UE Authentication_Authenticate Response).

The SEAF may send, to the PEGC, the PINE authentication indicator, EAP request (containing RAND, AUTN), and PINE identifier in the authentication request (e.g., a NAS message). The authentication request may be an Authentication Request.

The PEGC may forward the EAP request (containing RAND, AUTN) and the PINE authentication indicator received in the authentication request to the PINE via a secure non-3GPP second network. The PEGC may also receive the SN-Name in the PINE authentication request.

The PINE receives the RAND and AUTN carried in the received PINE authentication request. The PINE may determine whether the PINE authentication request is acceptable by checking the AUTN. For example, the PINE may verify the freshness of the received AUTN. If the PINE determines that the PINE authentication request is acceptable, the PINE may calculate the RES, for example, the PINE may first calculate the RES, CK, IK, and then the PINE ME may obtain the RES through the RES calculation.

After determining the RES, the PINE may send the RES to the core network device.

The PINE may return the PINE authentication response to the PEGC over the secure second class network of non-3GPP, and the PINE authentication response may include the EAP response, PINE Identifier, and PINE authentication indicator. The PINE authentication response may be a PINE Authentication Response. The EAP response carries the RES determined by the PINE.

The EAP response may be EAP-Response/AKA′-Challenge.

The PEGC may send the authentication response to the SEAF via the NAS message, and the authentication response may include the EAP response, PINE identifier and PINE authentication indicator. The authentication response may be an Authentication Response.

The SEAF may send the EAP response, PINE identifier, PINE authentication indicator and SUPI of the PEGI to the AUSF in the AUSF authentication request (Nausf_UE Authentication_Authenticate Request).

The AUSF performs the authentication on the PINE based on the authentication parameter and the expected authentication parameter.

When receiving the AUSF authentication request (Nausf_UE Authentication_Authenticate Request message) including the EAP response (containing RES) as the authentication confirmation, the AUSF may verify whether the maintained XRES has expired. If the XRES has expired, the AUSF may determine that the PINE authentication is unsuccessful. The AUSF may compare the received RES with the stored XRES. If the RES and XRES are equal, the AUSF may consider from the perspective of a home network that the authentication is successful.

The AUSF may indicate to the SEAF in the AUSF authentication response (Nausf_UEAuthentication_Authenticate Response) whether the PINE authentication is successful from the perspective of the home network.

In a possible implementation, in response to the AUSF determining that the authentication is successful, the AUSF may send an EAP success message to the SEAF in the Nausf_UE Authentication_Authenticate Response, and the SEAF may transparently forward the EAP success to the PEGC. If the AUSF receives a SUCI from the SEAF at the time of initiating the authentication (see subclause 6.1.2 of this document), the AUSF may also include the SUCI in the Nausf_UE Authentication_Authenticate Response message. The Nausf_UE Authentication Authenticate Response message contains the PINE authentication indicator and the decrypted PINE identifier.

For lawful interception, the AUSF sending SUPI to SEAF is necessary but not sufficient. By including the SUPI as input parameter to the key derivation of KAMF from KSEAF, additional assurance on the correctness of SUPI is achieved by the service network from both the home network and UE side.

In a possible implementation, in response to the SEAF receiving the EAP success message, the SEAF may send the EAP success message to the PEGC via an N1 message. The message also includes the PINE authentication indicator and the decrypted PINE identifier.

In a possible implementation, in response to the PEGC receiving the EAP success message, the PEGC sends the EAP success message and the PINE authentication indicator to the PINE over a secure non-3GPP connection.

The AUSF may indicate to the SEAF in the AUSF authentication response (Nausf_UE Authentication_Authenticate Response) whether or not the PINE authentication is successful from the perspective of the home network.

In an embodiment, the authentication parameter and the expected authentication parameter are identified using at least one of:
a PINE identifier of the PINE; or
a PEGC identifier of the PEGC.

In a possible implementation, the RES and XRES may each have a PINE identifier that is used respectively to indicate a corresponding PINE, and/or a PEGC identifier that indicates a corresponding PEGC. When storing the RES and/or XRES, the core network device may identify the same with the PINE identifier and/or PEGC identifier. For example, the AUSF may employ the PINE identifier when storing RES and/or XRES.

In a possible implementation, during the transmission of RES and XRES, it may be identified by using the PINE identifier and/or the PEGC identifier carried by a transmission message. The transmission message may include at least one of the UDM response, the AUSF response, the authentication request, the authentication response, the PINE authentication request, the PINE authentication response, or the AUSF authentication request.

In an embodiment, at least one of the authentication request, the authentication response, the PINE authentication request, the PINE authentication response, and the AUSF authentication request carries at least one of:
a PINE authentication indicator indicating to perform the authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

Here, the PINE authentication indicator may indicate, to the core network device (e.g., UDM, AUSF and SEAF), the PEGC and the PINE, that the received message is used for the PINE authentication.

The SUPI may indicate, to the core network device (e.g., UDM, AUSF and SEAF), the PEGC and the PINE, the PEGC to which the PINE to be authenticated is connected. The core network device and/or the PINE may send corresponding information to the PEGC indicated by the SUPI.

Here, the PINE identifier may indicate, to the core network device and the PEGC, the PINE to be authenticated.

In a possible implementation, the PINE identifier is a protected PINE identifier.

The protected PINE identifier may include an encrypted PINE identifier, an anonymous PINE identifier, or the like.

In a possible implementation, at least one of the UDM response, the AUSF response, the authentication request, the PINE authentication request, the PINE authentication response, the authentication response, or the AUSF authentication request carries the protected PINE identifier.

In a possible implementation, the network element of the core network device (e.g., UDM) restores the protected PINE identifier to a PINE identifier in a plaintext state in response to the PINE identifier being a protected PINE identifier.

At least one of the UDM response, the AUSF response, or the AUSF authentication request carries the PINE identifier in the plaintext state.

At least one of the authentication request, the PINE authentication request, the PINE authentication response, or the authentication response carries the protected PINE identifier.

When a network element of the core network device (e.g., UDM) receives a PINE identifier as a protected PINE identifier, it transforms the protected PINE identifier into a PINE identifier in a plaintext state by using a de-anonymizing manner, a decrypting manner and so on.

The PINE identifier in plaintext state may be used by the core network device during the transmission of the protected PINE identifier within the core network device. For example, at least one of the authentication request, the PINE authentication request, the PINE authentication response, or the authentication response carries the protected PINE identifier.

The protected PINE identifier may be used when the PINE identifier is communicated outside the core network device. That is, the protected PINE identifier is used in the communication between the three of SEAF, PEGC and PINE, for example, at least one of the authentication request, the PINE authentication request, the PINE authentication response, or the authentication response carries the protected PINE identifier.

In a possible implementation, if the PINE identifier received by the UDM is unprotected information (i.e., the PINE identifier in the plaintext state), the unprotected information (the PINE identifier in plaintext state) is used in the communication between the three of SEAF, PEGC and PINE. For example, at least one of the authentication request, the PINE authentication request, the PINE authentication response or the authentication response carries the PINE identifier in the plaintext state.

In an embodiment, the PINE authentication indicator indicates the core network device and the PINE not to perform at least one of:
generating an authentication service function key Kausf;
generating a security anchor function key Kseaf;
sending a key set identifier ngKSI to the PEGC; or
sending an anti-bidding down between architectures (ABBA) parameter to the PEGC.

In the related art, the UDM determines the Kausf during the authentication process. Here, the UDM may neither determine nor communicate the Kausf during the PINE authentication process, thereby reducing the load on the core network device. The authentication service function key KAUSF generates the security anchor function key KSEAF.

In the related art, the AUSF determines the Kseaf during the authentication process. Here, the AUSF may neither determine the Kseaf nor communicate the Kseaf during the PINE authentication process, thereby reducing the load of the core network device. The key set identifier ngKSI is an identifier of a key set used by the UE in the first class network, and is used to indicate that the first class network uses the same key set as the UE. The ABBA parameter is used for the AMF network element to generate the KAMF. The key set identifier (ngKSI, a key set identifier in 5G) may be used for the creation of the native security context if the authentication is successful. The anti-bidding down between architectures (ABBA) parameter prevents obfuscation of differentiated version security feature indication parameters.

Since the PINE accesses the first class network via the PEGC. Therefore, the SEAF may neither determine nor communicate the ngKSI and ABBA parameter, thereby reducing the load of the core network device.

In an embodiment, the method further includes: the core network device determining a first integrity protection key and a first confidentiality protection key at least based on a first service network name and the first credential of the PINE.

The EAP request is protected by the first integrity protection key and the first confidentiality protection key.

In a possible implementation, the AUSF may determine the first integrity protection key CK′ and the first confidentiality protection key IK′ for the EAP request based on the first credential and the first service network name. The first integrity protection key may be used for integrity protection of the EAP request, and the first confidentiality protection key may be used for confidentiality protection of the EAP request.

In an embodiment, the EAP request further includes first indication information configured to determine the first service network name.

The first indication information for determining the first service network name (SN-name) may be carried in the EAP request to be sent to the UE.

The first indication information may be used to indicate the first service network name, or the first indication information may be calculated at least with the first service network name by using a predetermined algorithm. With the first indication information, the UE may restore the first service network name.

For example, the first indication information may include a message authentication code (MAC) in the authentication token AUTN.

In a possible implementation, the PINE determines a second integrity protection key and a second confidentiality protection key at least based on the first service network name and a second credential.

The PINE employs the second integrity protection key and the second confidentiality protection key to verify the EAP request.

The PINE determines the first service network name corresponding to the PINE based on the first indication information.

In a possible implementation, the PINE may derive the second integrity protection key and the second confidentiality protection key at least based on the first service network name and the second credential.

The PINE may verify the EAP request based on the second integrity protection key and the second confidentiality protection key, for example, performing integrity verification and confidentiality verification.

In a possible implementation, in response to that verifying the EAP request fails, the PINE sends verifying failure information to the core network device to stop performing the EAP-AKA′ authentication on the PINE.

If the verification is successful, the EAP-AKA′ authentication process continues. Otherwise, the verifying failure information is sent to the core network device to stop performing the EAP-AKA′ authentication on the PINE. The PINE may discard the EAP request.

As shown in FIG. 7, the embodiment provides an authentication method that may be performed by a personal IoT network element with gateway capability (PEGC) of a cellular mobile communication system, including:

step 701, sending second indication information indicating a second service network name to the PINE.

Step 701 may be implemented alone or in combination with step 601.

The PINE determines the second service network name corresponding to the PINE based on the second indication information received from the PEGC.

In a possible implementation, the second indication information is carried in the authentication request sent by the PEGC to the PINE.

The second service network name (SN-name) is used to indicate the service network of the PINE.

After the EPA request is verified successfully using the second integrity protection key and the second confidentiality protection key, the PINE may also verify the consistency of the first service network name and the second service network name. If the first service network name and the second service network name are consistent, the EAP-AKA′ authentication process continues. Otherwise, the EAP-AKA′ authentication process is stopped.

In a possible implementation, in response to determining that the first service network name and the second service network name are not consistent, the PINE may generate local warming information, and continue sending the EAP response to the core network.

In a possible implementation, in response to determining that the first service network name and the second service network name are not consistent, the PINE may send error information to the core network to terminate the authentication process.

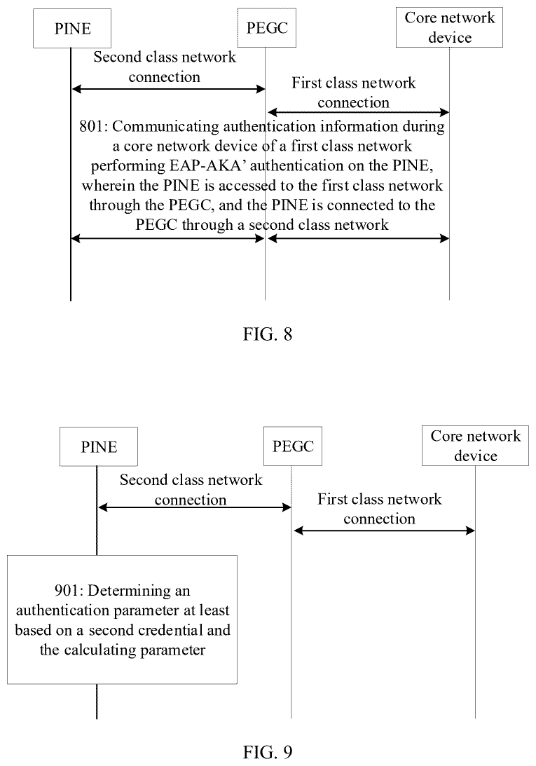

As shown in FIG. 8, the embodiment provides an authentication method that may be performed by a PINE of a cellular mobile communication system, including:

step 801, communicating authentication information during a core network device of a first class network performing EAP-AKA′ authentication on the PINE, wherein the PINE is accessed to the first class network through the PEGC, and the PINE is connected to the PEGC through a second class network.

In an embodiment, the first class network includes a 3rd generation partnership project (3GPP) standard network, and the second class network includes a non-3GPP standard network.

Here, the first class network may be a cellular mobile communication network meeting the 3GPP standard, such as a 5GS network. The second class network may be a non-3GPP standard network, and the second class network includes, but is not limited to, at least one of a Wi-Fi network, a Bluetooth network, a ZigBee network, or the like.

Here, the PINE may be a communication device in the IoT that may not directly access the first class network (e.g., a cellular mobile communication network such as 5GS), for example, the PINE may be a wearable device, a smart home appliance, a smart office device, or the like. The PEGC may be a communication device that can directly access the first class network (e.g., a cellular mobile communication network). The PEGC may have the capability of accessing both the first class network and the second class network. The PEGC may provide a communication device (e.g., a PINE) that may not directly access the first class network (e.g., a cellular mobile communication network) with a gateway service for accessing the first class network. The PEGC and the communication device that may not directly access the first class network may be connected via the second class network.

In an embodiment, the PEGC includes a user equipment (UE).

The PEGC may be a UE having the capability of accessing both the first class network and the second class network, for example, the PEGC may be a terminal device such as a mobile phone.

The PINE may access the 5GS via the PEGC, and the 5GS identifies the PINE for enhanced management. For example, the 5GS may determine the Quality of Service (QOS) for different PINEs and so on. Therefore, the core network device may perform authentication on the PINE.

Here, the EAP-AKA′ authentication on the PINE may be performed by the core network device. The PINE and the core network device may transmit to each other authentication information that needs to be transmitted during the authentication. Here the authentication information may include a PINE identifier, a root key or the like.

The EAP-AKA′ may be used for bidirectional authentication between the core network device and the PINE.

After performing the EAP-AKA′ authentication on the PINE, the core network device may implement 3GPP-compliant management for the PINE, for example, may adopt corresponding QoS and security policies for data transmission of the PINE or the like.

In this way, the EAP-AKA′ authentication on the PINE is performed by the core network device, so that the PINE may directly access the cellular mobile communication network, and the communication of the PINE within the first class network may be managed by the core network device to satisfy the management requirements of the core network device for the devices accessing the first class network, which satisfies data transmission requirements of the PINE and improves the reliability of data transmission.

In a possible implementation, the cellular mobile communication network provides the PINE with a credential. With the credential, the cellular mobile communication network may verify and identify the PINE connected to the PEGC.

In a possible implementation, the authentication on the PINE may be triggered by the PINE, the PEGC and/or the core network device. The EAP-AKA′ authentication on the PINE is triggered, and as shown in FIG. 3, the PINE triggers the core network device to trigger the authentication on the PINE, which may include the followings.

In step 301, the PINE sends a PINE identifier thereof (i.e., a device identifier of the PINE) to the PEGC over a non-3GPP connection (the second class network), and at the same time, sends an authentication method and a PINE authentication indicator. The non-3GPP connection (the second class network) established between the PINE and the PEGC may be a secure connection. How to establish the non-3GPP secure link is not limited here.

In step 302, the PEGC sends, via a NAS message, the PINE authentication indicator, the PINE identifier, the authentication method, an SUCI of the PEGC or a 5G-GUTI to an AMF/SEAF network element in the core network device.

In step 303, whenever the AMF wishes to initiate the PINE, the AMF may invoke a Nausf_UE Authentication service by sending a Nausf_UE Authentication_Authenticate Request message to the AUSF. The Nausf_UE Authentication_Authenticate Request message may contain the PINE authentication indicator, the PINE identifier, the authentication method, and a service network name (SN-Name).

In step 304, after receiving the Nausf_UE Authentication_Authenticate Request message, the AUSF may check, by comparing the service network name (SN-Name) with an expected service network name (SN-Name), whether the requesting AMF in the service network is authorized to use the service network name in the Nausf_UE Authentication_Authenticate Request. The AUSF may temporarily store the received service network name. If the service network is not authorized to use the service network name, the AUSF responds in the Nausf_UE Authentication_Authenticate Response with “service network not authorized”. If the service network is authorized to use the service network name, the AUSF sends, to the UDM, a Nudm_UE Authentication_Get Request message, which may include the PINE authentication indicator, the PINE identifier, the SUPI or SUCI of the PEGC, the authentication method, and the service network name.

In step 305, if the UDM receives the SUCI after receiving the Nudm_UE Authentication_Get Request, the UDM may invoke a subscription identifier de-concealing function (SIDF) to decrypt the SUCI to obtain the SUPI.

In step 306, the UDM/ARPF allows the PEGC to perform the authentication on the PINE according to the SUPI and the device identifier of the PEGC and based on the subscription verification of the PEGC, and then selects the authentication method for the PINE based on the PINE identifier and the authentication method sent by the PINE.

In the above method, the PINE may locally store the credential provided by the home network of the PEGC (i.e., the second class network). The PINE identifier of the PINE may be associated with the subscription information of the PEGC. The PEGC may be a gateway that has been registered into the 5GC, and the connection between the PEGC and the AMF is secured by the NAS. The AMF is juxtaposed with the SEAF.

In an embodiment, communicating the authentication information during the core network device of the first class network performing the EAP-AKA′ authentication on the PINE includes:
receiving an EAP request carrying a calculating parameter sent by the PEGC by means of the second class network, wherein the EAP request is sent by the core network device to the PEGC via a base station by means of the first class network, the calculating parameter is configured for the core network device to determine an expected authentication parameter at least in conjunction with a first credential, and the expected authentication parameter is configured for the core network device to perform the authentication on the PINE.

In the embodiment, the expected authentication parameter may be represented as XRES, and the authentication parameter may be represented as RES.

The PINE credential configured for the PINE by the first network may include a first credential stored in the core network device and a second credential stored in the PINE. For the same PINE, the first credential is identical to the second credential. The PINE credential may be used as a root key for EAP-AKA′ authentication on the PINE.

In a possible implementation, the PINE credential may be configured by the first network for the PINE. Different PINE credentials may correspond to different PINEs.

In an embodiment, the first credential is stored in the core network device.

In a possible implementation, the first credential is stored in the UDM.

In an embodiment, the first credential is determined by the core network device based on the PINE identifier of the PINE and/or the PEGC identifier of the PEGC.

In a possible implementation, the first credential may correspond to the PINE identifier of the PINE. Here, the PINE identifier may include a protected PINE identifier or a plaintext PINE identifier. The protected PINE identifier may include one of an anonymized PINE identifier or an encrypted PINE identifier.

In a possible implementation, the first credential may correspond to the PINE identifier of the PINE and/or the PEGC identifier of the PEGC for the PINE. The PINE identifier may uniquely identify the PINE, and the PEGC identifier may uniquely identify the PEGC.

The core network device may determine the first credential corresponding to the PINE based on the PINE identifier of the PINE and/or the PEGC identifier. Here, the PINE identifier may be carried by trigger information that triggers the core network device to perform the authentication on the PINE. For example, the trigger information may be Nudm_UE Authentication_Get Request or the like.

The core network device may determine the XRES based on at least the first credential and the calculating parameter.

The calculating parameter may be at least one parameter employed in the process of calculating the XRES. Here, the calculating manner employed by the core network device to determine the XRES may be the same as the calculating manner employed by the PINE to determine the RES.

In an embodiment, the calculating parameter includes at least a random number RAND.

The calculating parameter may be a random number used to calculate the XRES.

The core network device may send the calculating parameter to the PINE, which determines the RES in conjunction with the stored second credential. The PINE may determine the RES based on a similar method as described above, which is not repeated herein.

As shown in FIG. 9, the embodiment provides an authentication method that may be performed by a PINE of a cellular mobile communication system, including:

step 901, determining an authentication parameter at least based on a second credential and the calculating parameter.

Communicating the authentication information during the core network device of the first class network performing the authentication on the PINE comprises:

sending an EAP response carrying the authentication parameter to the PEGC by means of the second class network, the EAP response being sent to the core network device by the PEGC via the base station by means of the first class network and configured for the core network device to perform the authentication on the PINE at least based on the authentication parameter and the expected authentication parameter.

The core network device, after determining the XRES, may send the EAP request to the PEGC for the PINE via the second class network. The EAP request may include the calculating parameter. Here the EAP request may be sent by the PEGC to the PINE for the PINE to determine the RES based on the second credential, the calculating parameter or the like. The second credential may be determined by the first network, e.g., may be determined by the core network device of the first network, and may be sent by the first network to the PINE via the PEGC.

In a possible implementation, the EAP request may further include information for the EAP-AKA′ authentication such as CK′ and IK′, which will not be repeated herein.

The EAP request may be an EAP-Request/AKA′-Challenge.

The core network device may determine whether the EAP-AKA′ authentication on the PINE is successful at least based on a comparison between RES and XRES.

The calculating method used by the core network to determine XRES and the calculating method used by the PINE to determine RES may be the same. In the case where the calculating methods are the same, if the calculating parameters or the like used in the calculating process are the same, XRES and RES are the same, and if the calculating parameters or the like used in the calculating process are different, XRES and RES are different.

If the first credential is the same as the second credential, then the RES and ERES determined based on the same calculating parameter are also the same, and thus the PINE authentication is successful.

If the first credential is not the same as the second credential, then the RES and ERES determined based on the same calculating parameter are not the same either, and thus the PINE authentication fails.

In an embodiment, the first credential is determined by the UDM in the core network device based on the PINE identifier of the PINE and/or the PEGC identifier of the PEGC.

The trigger information for triggering the authentication on the PINE may be sent to the UDM. The UDM may determine the first credential of the PINE based on the PINE identifier and/or the PEGC identifier of the PEGC.

The first credential may be stored in the UDM, and the XRES may be determined by the UDM, which in turn initiates the authentication on the PINE.

The XRES may be used to compare with the RES calculated by the PINE, thereby determining whether the second credential of the PINE or the like is identical to the first credential or the like in the UDM, thereby determining the identifier of the PINE and completing the authentication on the PINE. The UDM may include an authentication credential repository and processing function (ARPF).

For example, for each Nudm_Authenticate_Get Request shown in FIG. 3, the UDM/ARPF creates a 5G HE AV for the PINE based on the locally stored PINE credential, i.e., the first credential, which may be achieved by the UDM/ARPF generating an AV with an authentication management field (AMF) separation bit set to be “1”. The UDM/ARPF may then calculate the XRES. The UDM/ARPF may create an AV′, which may include: a RAND, an authentication token (AUTN), and an XRES.

In a possible implementation, the AV′ may also include an integrity key CK′ and an encryption key IK′. The CK′ and IK′ may also be determined based on the first credential and the calculating parameter. The CK′ and IK′ may be sent to the PINE along with the calculating parameter.

In a possible implementation, the core network device such as UDM determines, based on judging information, whether the PEGC is a legitimate gateway for the PEGC to access the first class network, wherein the judging information includes at least one of:
the PEGC identifier of the PEGC;
the PINE identifier of the PINE; or
subscription information of the PEGC.

The core network device determines that the PEGC is the legitimate gateway, and determines the expected authentication parameter based on the calculating parameter and the first credential of the PINE.

Before the UDM determines the XRES, the UDM may also determine whether the PEGC is a legitimate gateway for the PINE. The UDM may first determine whether the PEGC is a legitimate gateway in the first class network based on the judging information. For example, the UDM may make a judgement based on the PEGC identifier. The UDM may then determine whether the PEGC is a legitimate gateway for the PINE, for example, it may determine whether the PEGC is allowed to access the PINE into the first class network. The UDM may make the judgement based on the PEGC identifier, the PINE identifier of the PINE, and the subscription information of the PEGC. For example, when the subscription information of the PEGC identified by the PEGC identifier has the PINE identifier of the PINE, the PEGC is determined to be the legitimate gateway for the PINE.

The PEGC identifier may include a subscription concealed identifier (SUCI) and/or

a subscription permanent identifier (SUPI).

In an embodiment, receiving the EAP request carrying the calculating parameter sent by the PEGC by means of the second class network includes:
receiving a PINE authentication request carrying the EAP request sent by the PEGC by means of the second class network.

Sending the EAP response carrying the authentication parameter to the PEGC by means of the second class network includes:
sending a PINE authentication response carrying the EAP response to the PEGC by means of the second class network.

The UDM may carry the calculating parameter (e.g., RAND) in the UDM response to be sent to the AUSF. The UDM response may be a Nudm_UE Authentication_Get Response. For example, the UDM may return AV′ in the Nudm_UE Authentication_Get Response to the AUSF. The AV′ may include RAND, AUTN, and XRES. The UDM response may carry a PINE authentication indicator indicating to perform the authentication on the PINE. The AUSF may determine, based on the PINE authentication indicator, that the UDM response is used to perform the EAP-AKA′ authentication on the PINE.

If the PINE identifier and the SUCI of the PEGI are included in the Nudm_UE Authentication_Get Request, the UDM may include the PINE identifier and the SUCI of the PEGI in the Nudm_UEAuthentication_Get Response after de-concealment of the SUCI by the SIDF.

The AUSF may store the XRES, PINE identifier, and SUPI.

The AUSF may return the EAP request (which may contain RAND and AUTN), the PINE authentication indicator, the SUPI of the PEGC, and the PINE identifier to the SEAF in the AUSF response (e.g., Nausf_UE Authentication_Authenticate Response).

The SEAF may send, to the PEGC, the PINE authentication indicator, EAP request (containing RAND, AUTN), and PINE identifier in the authentication request (e.g., a NAS message). The authentication request may be an Authentication Request.

The PEGC may forward the EAP request (containing RAND, AUTN) and the PINE authentication indicator received in the authentication request to the PINE via a secure non-3GPP second network. The PEGC may also receive the SN-Name in the PINE authentication request.

The PINE receives the RAND and AUTN carried in the received PINE authentication request. The PINE may determine whether the PINE authentication request is acceptable by checking the AUTN. For example, the PINE may verify the freshness of the received AUTN. If the PINE determines that the PINE authentication request is acceptable, the PINE may calculate the RES, for example, the PINE may first calculate the RES, CK, IK, and then the PINE ME may obtain the RES through the RES calculation.

After determining the RES, the PINE may send the RES to the core network device.

The PINE may return the PINE authentication response to the PEGC over the secure second class network of non-3GPP, and the PINE authentication response may include the EAP response, PINE Identifier, and PINE authentication indicator. The PINE authentication response may be a PINE Authentication Response. The EAP response carries the RES determined by the PINE.

The EAP response may be EAP-Response/AKA′-Challenge.

The PEGC may send the authentication response to the SEAF via the NAS message, and the authentication response may include the EAP response, PINE identifier and PINE authentication indicator. The authentication response may be an Authentication Response.

The SEAF may send the EAP response, PINE identifier, PINE authentication indicator and SUPI of the PEGI to the AUSF in the AUSF authentication request (Nausf_UE Authentication_Authenticate Request).

The AUSF performs the authentication on the PINE based on the authentication parameter and the expected authentication parameter.

When receiving the AUSF authentication request (Nausf_UE Authentication_Authenticate Request message) including the EAP response (containing RES) as the authentication confirmation, the AUSF may verify whether the maintained XRES has expired. If the XRES has expired, the AUSF may determine that the PINE authentication is unsuccessful. The AUSF may compare the received RES with the stored XRES. If the RES and XRES are equal, the AUSF may consider from the perspective of a home network that the authentication is successful.

The AUSF may indicate to the SEAF in the AUSF authentication response (Nausf_UEAuthentication_Authenticate Response) whether the PINE authentication is successful from the perspective of the home network.

In a possible implementation, in response to the AUSF determining that the authentication is successful, the AUSF may send an EAP success message to the SEAF in the Nausf_UE Authentication_Authenticate Response, and the SEAF may transparently forward the EAP success to the PEGC. If the AUSF receives a SUCI from the SEAF at the time of initiating the authentication (see subclause 6.1.2 of this document), the AUSF may also include the SUCI in the Nausf_UE Authentication_Authenticate Response message. The Nausf_UE Authentication Authenticate Response message contains the PINE authentication indicator and the decrypted PINE identifier.

For lawful interception, the AUSF sending SUPI to SEAF is necessary but not sufficient. By including the SUPI as input parameter to the key derivation of KAMF from KSEAF, additional assurance on the correctness of SUPI is achieved by the service network from both the home network and UE side.

In a possible implementation, in response to the SEAF receiving the EAP success message, the SEAF may send the EAP success message to the PEGC via an N1 message. The message also includes the PINE authentication indicator and the decrypted PINE identifier.

In a possible implementation, in response to the PEGC receiving the EAP success message, the PEGC sends the EAP success message and the PINE authentication indicator to the PINE over a secure non-3GPP connection.

The AUSF may indicate to the SEAF in the AUSF authentication response (Nausf_UE Authentication_Authenticate Response) whether or not the PINE authentication is successful from the perspective of the home network.

In an embodiment, the authentication parameter and the expected authentication parameter are identified using at least one of:
a PINE identifier of the PINE; or a PEGC identifier of the PEGC.

In a possible implementation, the RES and XRES may each have a PINE identifier that is used respectively to indicate a corresponding PINE, and/or a PEGC identifier that indicates a corresponding PEGC. When storing the RES and/or XRES, the core network device may identify the same with the PINE identifier and/or PEGC identifier. For example, the AUSF may employ the PINE identifier when storing RES and/or XRES.

In a possible implementation, during the transmission of RES and XRES, it may be identified by using the PINE identifier and/or the PEGC identifier carried by a transmission message. The transmission message may include at least one of the UDM response, the AUSF response, the authentication request, the authentication response, the PINE authentication request, the PINE authentication response, or the AUSF authentication request.

In an embodiment, the PINE authentication request and/or the PINE authentication response carries at least one of:
a PINE authentication indicator indicating to perform the authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

Here, the PINE authentication indicator may indicate, to the core network device (e.g., UDM, AUSF and SEAF), the PEGC and the PINE, that the received message is used for the PINE authentication.

The SUPI may indicate, to the core network device (e.g., UDM, AUSF and SEAF), the PEGC and the PINE, the PEGC to which the PINE to be authenticated is connected. The core network device and/or the PINE may send corresponding information to the PEGC indicated by the SUPI.

Here, the PINE identifier may indicate, to the core network device and the PEGC, the PINE to be authenticated.

In a possible implementation, the PINE identifier is a protected PINE identifier.

The protected PINE identifier may include an encrypted PINE identifier, an anonymous PINE identifier, or the like.

In a possible implementation, at least one of the UDM response, the AUSF response, the authentication request, the PINE authentication request, the PINE authentication response, the authentication response, or the AUSF authentication request carries the protected PINE identifier.

In a possible implementation, the core network device (e.g., UDM) restores the protected PINE identifier to a PINE identifier in a plaintext state in response to the PINE identifier being a protected PINE identifier.

At least one of the UDM response, the AUSF response, or the AUSF authentication request carries the PINE identifier in the plaintext state

At least one of the authentication request, the PINE authentication request, the PINE authentication response, or the authentication response carries the protected PINE identifier.

When a network element of the core network device (e.g., UDM) receives a PINE identifier as a protected PINE identifier, it transforms the protected PINE identifier into a PINE identifier in a plaintext state by using a de-anonymizing manner, a decrypting manner and so on.

The PINE identifier in plaintext state may be used by the core network device during the transmission of the protected PINE identifier within the core network device. For example, at least one of the authentication request, the PINE authentication request, the PINE authentication response, or the authentication response carries the protected PINE identifier.

The protected PINE identifier may be used when the PINE identifier is communicated outside the core network device. That is, the protected PINE identifier is used in the communication between the three of SEAF, PEGC and PINE, for example, at least one of the authentication request, the PINE authentication request, the PINE authentication response, or the authentication response carries the protected PINE identifier.

In a possible implementation, if the PINE identifier received by the UDM is unprotected information (i.e., the PINE identifier in the plaintext state), the unprotected information (the PINE identifier in plaintext state) is used in the communication between the three of SEAF, PEGC and PINE. For example, at least one of the authentication request, the PINE authentication request, the PINE authentication response or the authentication response carries the PINE identifier in the plaintext state.

In an embodiment, the PINE authentication indicator indicates the core network device and the PINE not to perform at least one of:
generating an authentication service function key Kausf;
generating a security anchor function key Kseaf;
sending a key set identifier ngKSI to the PEGC; or
sending an anti-bidding down between architectures (ABBA) parameter to the PEGC.

In the related art, the UDM determines the Kausf during the authentication process. Here, the UDM may neither determine nor communicate the Kausf during the PINE authentication process, thereby reducing the load on the core network device. The authentication service function key KAUSF generates the security anchor function key KSEAF.

In the related art, the AUSF determines the Kseaf during the authentication process. Here, the AUSF may neither determine the Kseaf nor communicate the Kseaf during the PINE authentication process, thereby reducing the load of the core network device. The key set identifier ngKSI is an identifier of a key set used by the UE in the first class network, and is used to indicate that the first class network uses the same key set as the UE. The ABBA parameter is used for the AMF network element to generate the KAMF. The key set identifier (ngKSI, a key set identifier in 5G) may be used for the creation of the native security context if the authentication is successful. The anti-bidding down between architectures (ABBA) parameter prevents obfuscation of differentiated version security feature indication parameters.

Since the PINE accesses the first class network via the PEGC. Therefore, the SEAF may neither determine nor communicate the ngKSI and ABBA parameter, thereby reducing the load of the core network device.

In a possible implementation, the method further includes: the core network device determining a first integrity protection key and a first confidentiality protection key at least based on a first service network name and the first credential of the PINE.

The EAP request is protected by the first integrity protection key and the first confidentiality protection key.

In a possible implementation, the AUSF may determine the first integrity protection key CK′ and the first confidentiality protection key IK′ for the EAP request based on the first credential and the first service network name. The first integrity protection key may be used for integrity protection of the EAP request, and the first confidentiality protection key may be used for confidentiality protection of the EAP request.

In an embodiment, the EAP request further includes first indication information configured to determine the first service network name.

The first indication information for determining the first service network name (SN-name) may be carried in the EAP request to be sent to the UE.

The first indication information may be used to indicate the first service network name, or the first indication information may be calculated at least with the first service network name by using a predetermined algorithm. With the first indication information, the UE may restore the first service network name.

For example, the first indication information may include a message authentication code (MAC) in the authentication token AUTN.

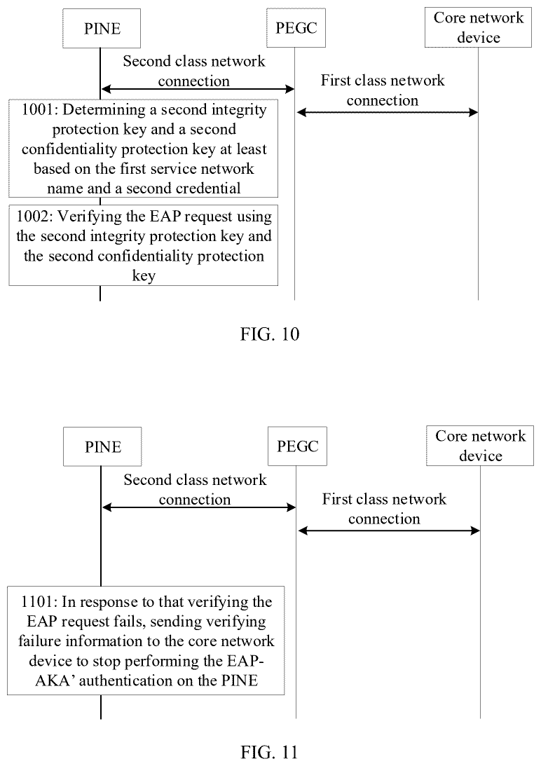

As shown in FIG. 10, the embodiment provides an authentication method that may be performed by a PINE of a cellular mobile communication system, including:
step 1001, determining a second integrity protection key and a second confidentiality protection key at least based on the first service network name and a second credential; and
step 1002, verifying the EAP request using the second integrity protection key and the second confidentiality protection key.

Step 1001 and/or step 1002 may be implemented alone or in combination with step 801 and/or step 901.

The PINE determines the first service network name corresponding to the PINE based on the first indication information.

In a possible implementation, the PINE may derive the second integrity protection key and the second confidentiality protection key at least based on the first service network name and the second credential.

The PINE may verify the EAP request based on the second integrity protection key and the second confidentiality protection key, for example, performing integrity verification and confidentiality verification.

As shown in FIG. 11, the embodiment provides an authentication method that may be performed by a PINE of a cellular mobile communication system, including:
step 1101, in response to that verifying the EAP request fails, sending verifying failure information to the core network device to stop performing the EAP-AKA′ authentication on the PINE.

Step 1101 may be implemented alone or in combination with step 801, step 901, step 1001 and/or step 1002.

If the verification is successful, the EAP-AKA′ authentication process continues. Otherwise, the verifying failure information is sent to the core network device to stop performing the EAP-AKA′ authentication on the PINE. The PINE may discard the EAP request.

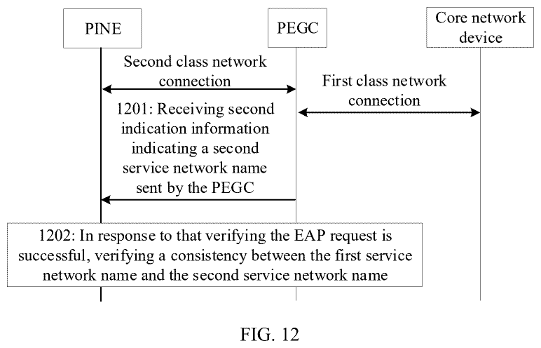

As shown in FIG. 12, the embodiment provides an authentication method that may be performed by a PINE of a cellular mobile communication system, including:
step 1201, receiving second indication information indicating a second service network name sent by the PEGC; and
step 1202, in response to that verifying the EAP request is successful, verifying a consistency between the first service network name and the second service network name.

Step 1201 and/or step 1202 may be implemented alone or in combination with step 801, step 901, step 1001, step 1002 and/or step 1101.

The PINE determines the second service network name corresponding to the PINE based on the second indication information received from the PEGC.

In a possible implementation, the second indication information is carried in the authentication request sent by the PEGC to the PINE.

The second service network name (SN-name) is used to indicate the service network of the PINE.

After the EPA request is verified successfully using the second integrity protection key and the second confidentiality protection key, the PINE may also verify the consistency of the first service network name and the second service network name. If the first service network name and the second service network name are consistent, the EAP-AKA′ authentication process continues. Otherwise, the EAP-AKA′ authentication process is stopped.

In a possible implementation, in response to determining that the first service network name and the second service network name are not consistent, the PINE may generate local warming information, and continue sending the EAP response to the core network.

In a possible implementation, in response to determining that the first service network name and the second service network name are not consistent, the PINE may send error information to the core network to terminate the authentication process.

A specific example is provided below in conjunction with any of the above embodiments

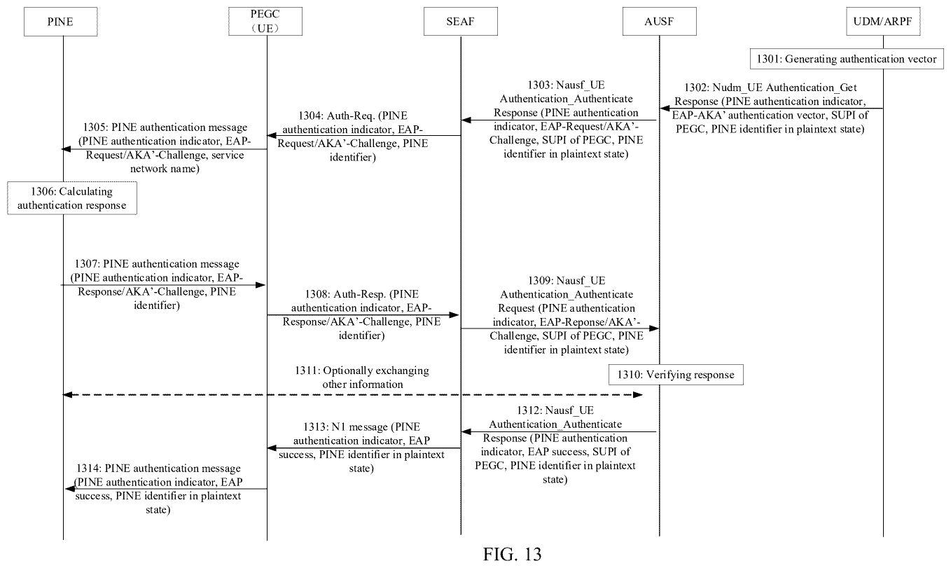

The PINE authentication is shown in FIG. 13. Here, the PEGC may be a UE. It is assumed that the PINE identifier is encrypted. The UDM may call a function to decrypt the encrypted PINE identifier.

It is assumed that the SEAF, AUSF and UDM receive the PINE identifier and the SUCI of the PEGC when the PINE requests authentication.

It is also assumed that the PINE is connected to the PEGC via secure non-3GPP access.

The authentication on the PINE specifically includes the followings.

In step 1301, the UDM/ARPF may first generate an authentication vector (AV) with an authentication management field (AMF) separation bit=1, as defined in TS33.102 [X]. The UDM/ARPF may then calculate CK′ and IK′ and replace CK and IK with CK′ and IK′. For example, CK′ and IK′ may be calculated according to normative annex A of TS 33.501 [1].

In step 1302, the UDM subsequently sends the transformed authentication vector AV′ (including RAND, AUTN, XRES, CK′ and IK′) to the AUSF, from which the UDM receives a Nudm_UE Authentication_Get Request and an indication for indicating to adopt the AV′ in the Nudm_UE Authentication_Get Response for EAP-AKA.

The Nudm_UE Authentication_Get Response message also contains the PINE authentication indicator and the decrypted PINE identifier (PINE identifier in the plaintext state), and the decrypted PINE identifier indicates that the message (Nudm_UE Authentication_Get Response) is used to authenticate the PINE identified by the decrypted PINE identifier. It is assumed that the UDM can identify the credential of the PINE based on the PINE identifier/decrypted PINE identifier. The credential of the PINE is used s as the root key K for deriving the expected authentication parameter (XRES).

For example, the exchange of the Nudm_UE Authentication_Get Request and the Nudm_UE Authentication_Get Response between the AUSF and the UDM/ARPF is the same as the trusted access using EAP-AKA′ described in TS33.402 [X] subclause 6.2, step 10, except for the input parameter to the key derivation, which is the value of <network name>. The “Network name” is a concept from RFC 5448 [X]; and it is carried in the AT_KDF_INPUT attribute in EAP-AKA′. The value of the <network name> parameter is not defined in RFC5448 [X], but in the 3GPP specification. For EPS, it is defined as “access network identifier” in TS24.302 [X], and for 5G, it is defined as “serve network name (SNN)” in sub-clause 6.1.1.4 of the present document.

The UDM may carry the SUPI of the PEGC in the Nudm_UE Authentication_Get Response if the SUCI of the PEGC is included in Nudm_UE Authentication_Get step 10.

In step 1303, the AUSF may send an EAP-Request/AKA′-Challenge message to the SEAF in the Nausf_UE Authentication_Authenticate Response. The Nausf_UE Authentication_Authenticate Response also includes the SUPI of the PEGC, the PINE authentication indicator and the decrypted PINE identifier. The AUSF may map the AV′ to the SUPI of the PEGC and the PINE identifier/decrypted PINE identifier.

In step 1304, the SEAF transparently forwards the EAP-Request/AKA′-Challenge message to the PEGC (UE) in the NAS message authentication request message. The NAS message authentication request message also includes the PINE identifier.

The SEAF evaluates the type of authentication based on the Nausf_UE Authentication_Authenticate Response message to determine that the authentication method used is the EAP method.

In a possible implementation, the message transmitted between the PEGC and the SEAF may adopt a uniform form of PINE identifier. For example, the messages transmitted between the PEGC and the SEAF may adopt an encrypted PINE identifier or a PINE identifier in a plaintext state.

In step 1305, the PEGC transparently forwards the EAP-Request/AKA′-Challenge message and the service network name (SNN) to the PINE via a PIN element authentication message (e.g., PINE authentication request), where the PINE is identified by the PINE identifier.

In step 1306, upon receipt of the RAND and AUTN, the USIM of the PINE verifies the freshness of the AV′ by checking whether the AUTN is acceptable. For example, the method described in TS 33.102 [X] may be used. If yes, the USIM of the PINE calculates the authentication parameter (RES). The USIM of the PINE returns RES, CK, IK to the ME of the PINE. If the USIM of the PINE calculates Kc (i.e., GPRS Kc) from CK and IK using the conversion function c3 as described in TS33.102 [X] and sends it to the ME of the PINE, the ME of the PINE ignores such GPRS Kc and does not store the GPRS Kc in the USIM or ME. The ME of the PINE derives CK′ and IK′ according to Annex A.3. Specifically, the service network name (SNN) used to derive CK′ and IK′ is provided by the PEGC.

If the AUTN verification fails on the USIM of the PINE, the USIM of the PINE and the ME of the PINE proceed as described in 6.1.3.

In step 1307, the PINE may send the PINE authentication indicator, the EAP-Response/AKA′-Challenge message, and the PINE identifier to the PEGC via a secure non-3GPP connection.

In step 1308, the PEGC (e.g., UE) may send the PINE authentication indicator, the EAP-Response/AKA′-Challenge message, and the PINE identifier to the SEAF in a NAS message authentication response (Auth-Resp.) message.

In step 1309, the SEAF may send the PINE authentication indicator, the EAP-Response/AKA′-Challenge message, and the PINE identifier to the AUSF in Nausf_UE Authentication_Authenticate Response.

In step 1310, the AUSF may verify the message by comparing XRES and RES, and if the AUSF successfully verifies this message, it continues with the following steps, otherwise it returns an error to the SEAF. Specifically, the AUSF may identify the corresponding XRES based on the received decrypted PINE identifier. The AUSF may inform the UDM of the authentication result. If the verification of the EAP-Response/AKA′-Challenge message is unsuccessful, the subsequent AUSF behaviour is determined according to the policy of the home network.

In step 1311, the AUSF and the PINE may exchange EAP-Request/AKA′-Notification and EAP-Response/AKA′-Notification messages via the SEAF. The PEGC and the SEAF may transparently forward these messages.

In step 1312, the AUSF may send an EAP success message to the SEAF in the Nausf_UE Authentication_Authenticate Response, and the SEAF may transparently forward the EAP success to the PEGC. If the AUSF receives SUCI from the SEAF at the time of initiating authentication (see sub-clause 6.1.2 of this document), the AUSF may also include the SUPI in the Nausf_UE Authentication_Authenticate Response message. The Nausf_UE Authentication_Authenticate response message contains the PINE authentication indicator and the decrypted PINE identifier.

For lawful interception, the AUSF sending SUPI to SEAF is necessary but not sufficient. By including the SUPI as input parameter to the key derivation of KAMF from KSEAF, additional assurance on the correctness of SUPI is achieved by the service network from both the home network and UE side.

In step 1313, the SEAF may send an EAP success message to the PEGC in a N1 message. The message also includes the PINE authentication indicator and the decrypted PINE identifier. Step 1313 may be a NAS security mode command or an authentication result.

In step 1314, the PEGC sends the EAP success message and the PINE authentication indicator to the PINE via a secure non-3GPP connection.

In a possible implementation, the message transmitted between the PEGC and the PINE may adopt a uniform form of PINE identifier. For example, the messages transmitted between the PEGC and the PINE may adopt a PINE identifier in a plaintext state.

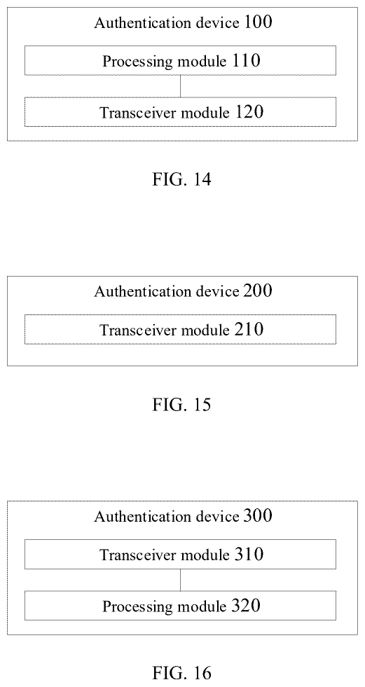

As shown in FIG. 14, the embodiment provides an authentication device 100, which may be applied to a core network device of a cellular mobile communication system, including:
a processing module 110, configured to perform extensible authentication protocol-authentication and key agreement′ (EAP-AKA′) authentication on a personal IoT network element (PINE), wherein the PINE is accessed to the first class network through a personal IoT network element with gateway capability (PEGC), and the PINE is connected to the PEGC through a second class network.

In an embodiment, the processing module 110 is specifically configured to:
determine an expected authentication parameter at least based on a calculating parameter and a first credential of the PINE; and
perform the authentication on the PINE at least based on the expected authentication parameter.

In an embodiment, the first credential is stored in the core network device.

In an embodiment, the first credential is determined by the core network device based on a PINE identifier of the PINE and/or a PEGC identifier of the PEGC.

In an embodiment, the device further includes:
a transceiver module 120, configured to send an EAP request to the PEGC via a base station by means of the first class network, wherein the EAP request at least includes the calculating parameter, and the calculating parameter is sent through the EAP request to the PINE by means of a second class network;
the transceiver module 120 is further configured to receive an EAP response sent by the PEGC via the base station by means of the first class network, wherein the EAP response at least includes an authentication parameter, and the authentication parameter is determined by the PINE at least based on a second credential and the calculating parameter and is carried in the EAP response to be sent to the PEGC by means of the second class network; and
the processing module 110 is specifically configured to perform the EAP-AKA′ authentication on the PINE at least based on a comparison of the authentication parameter and the expected authentication parameter.

In an embodiment, the transceiver module 120 is specifically configured to perform at least one of:
sending, by a unified data management (UDM) in the core network device, a UDM response carrying the EAP request to an authentication service function (AUSF) in the core network device;
sending, by the AUSF, an AUSF response carrying the EAP request to a security anchor function (SEAF) in the core network device; or
sending, by the SEAF, an authentication request carrying the EAP request to the PEGC via the base station by means of the first class network, wherein the EAP request is carried in a PINE authentication request by the PEGC to be sent to the PINE.

In an embodiment, the transceiver module 120 is specifically configured to perform at least one of:
receiving, by the SEAF, an authentication response carrying the EAP response sent by the PEGC via the base station by means of the first class network, wherein the EAP response is carried in a PINE authentication response by the PINE to be sent to the PEGC by means of the second class network; or
receiving, by the AUSF, an AUSF authentication request carrying the EAP response sent by the SEAF.

In an embodiment, at least one of the UDM response, the AUSF response, the authentication request, the authentication response, the PINE authentication request, the PINE authentication response or the AUSF authentication request carries at least one of:
a PINE authentication indicator indicating to perform the EAP-AKA′ authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

In an embodiment, the processing module 110 is further configured to, in response to the PINE identifier being a protected PINE identifier, restore the protected PINE identifier to a PINE identifier in a plaintext state,
wherein at least one of the UDM response, the AUSF response, or the AUSF authentication request carries the PINE identifier in the plaintext state, and
at least one of the authentication request, the PINE authentication request, the PINE authentication response, or the authentication response carries the protected PINE identifier.

In an embodiment, the PINE authentication indicator indicates the core network device and the PINE not to perform at least one of:
generating an authentication service function key Kausf;
generating a security anchor function key Kseaf;
sending a key set identifier ngKSI to the PEGC; or
sending an anti-bidding down between architectures (ABBA) parameter to the PEGC.

In an embodiment, the authentication parameter and the expected authentication parameter are identified using at least one of:
a PINE identifier of the PINE; or
a PEGC identifier of the PEGC.

In an embodiment, the processing module 110 is further configured to
determine a first integrity protection key and a first confidentiality protection key at least based on a first service network name and the first credential of the PINE,
wherein the EAP request is protected by the first integrity protection key and the first confidentiality protection key.

In an embodiment, the EAP request further includes first indication information configured to determine the first service network name.

In an embodiment, the processing module 110 is further configured to determine, based on judging information, whether the PEGC is a legitimate gateway for the PEGC to access the first class network, wherein the judging information includes at least one of:
a PEGC identifier of the PEGC;
a PINE identifier of the PINE; or
subscription information of the PEGC, and
wherein determining the expected authentication parameter at least based on the calculating parameter and the first credential of the PINE includes:
determining the PEGC as the legitimate gateway; and
determining the expected authentication parameters based on the calculating parameter and the first credential of the PINE.

In an embodiment, the first credential is determined by a UDM in the core network device based on a PINE identifier of the PINE and/or a PEGC identifier of the PEGC.

In an embodiment, the first class network includes a 3rd generation partnership project (3GPP) standard network, and
the second class network includes a non-3GPP standard network.

As shown in FIG. 15, the embodiment provides an authentication device 200, which may be applied to a PEGC, including:
a transceiver module 210, configured to communicate authentication information during a core network device of a first class network performing extensible authentication protocol-authentication and key agreement′ (EAP-AKA′) authentication on a personal IoT network element (PINE), wherein the PINE is accessed to the first class network through the PEGC, and the PINE is connected to the PEGC through a second class network.

In an embodiment, the transceiver module 210 is specifically configured to:
receive an EAP request carrying a calculating parameter sent by the core network device to the PEGC via a base station by means of the first class network, wherein the calculating parameter is configured for the core network device to determine an expected authentication parameter at least in conjunction with a first credential, and the expected authentication parameter is configured for the core network device to perform the authentication on the PINE.

In an embodiment, the first credential is determined by the core network device based on a PINE identifier of the PINE and/or a PEGC identifier of the PEGC.

In an embodiment, the transceiver module 210 is specifically configured to:
send the EAP request carrying the calculating parameter to the PINE by means of the second class network;
receive an EAP response carrying an authentication parameter sent by the PINE by means of the second class network, wherein the authentication parameter is determined by the PINE at least based on a second credential and the calculating parameter; and
send the EAP response carrying the authentication parameter to the core network device via the base station by means of the first class network, wherein the authentication parameter is configured for the core network device to perform the authentication on the PINE at least based on the expected authentication parameter.

In an embodiment, the transceiver module 210 is specifically configured to perform at least one of:
receiving an authentication request carrying the EAP request sent by an SEAF in the core network device via the base station by means of the first class network,
sending a PINE authentication request carrying the EAP request to the PINE by means of the second class network,
receiving a PINE authentication response carrying the EAP response sent by the PINE by means of the second class network, or
sending an authentication response carrying the EAP response to the SEAF via the base station by means of the first class network.

In an embodiment, wherein at least one of the authentication request, the authentication response, the PINE authentication request or the PINE authentication response carries at least one of:
a PINE authentication indicator indicating to perform the authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

In an embodiment, the PINE authentication indicator indicates the core network device and the PINE not to perform at least one of:
generating an authentication service function key Kausf;
generating a security anchor function key Kseaf;
sending a key set identifier ngKSI to the PEGC; or
sending an anti-bidding down between architectures (ABBA) parameter to the PEGC.

In an embodiment, the EAP request further includes first indication information configured to determine a first service network name.

In an embodiment, the transceiver module 210 is further configured to:
send second indication information indicating a second service network name to the PINE.

As shown in FIG. 16, the embodiment provides an authentication device 300, which may be applied to a PINE, including:

A sixth aspect of embodiments of the present disclosure provides an authentication device, including:
a transceiver module 310, configured to communicate authentication information during a core network device of a first class network performing extensible authentication protocol-authentication and key agreement′ (EAP-AKA′) authentication on the PINE, wherein the PINE is accessed to the first class network through a personal IoT network element with gateway capability (PEGC), and the PINE is connected to the PEGC through a second class network.

In an embodiment, the transceiver module 310 is specifically configured to:
receive an EAP request carrying a calculating parameter sent by the PEGC by means of the second class network, wherein the EAP request is sent by the core network device to the PEGC via a base station by means of the first class network, the calculating parameter is configured for the core network device to determine an expected authentication parameter at least in conjunction with a first credential, and the expected authentication parameter is configured for the core network device to perform the authentication on the PINE.

In an embodiment, the first credential is determined by the core network device based on a PINE identifier of the PINE and/or a PEGC identifier of the PEGC.

In an embodiment, the device further includes:
a processing module 320, configured to determine an authentication parameter at least based on a second credential and the calculating parameter,
the transceiver module 310 is specifically configured to:
send an EAP response carrying the authentication parameter to the PEGC by means of the second class network, the EAP response being sent to the core network device by the PEGC via the base station by means of the first class network and configured for the core network device to perform the authentication on the PINE at least based on the authentication parameter and the expected authentication parameter.

In an embodiment, the transceiver module 310 is specifically configured to perform at least one of:
receiving a PINE authentication request carrying the EAP request sent by the PEGC by means of the second class network, or
sending a PINE authentication response carrying the EAP response to the PEGC by means of the second class network.

In an embodiment, the PINE authentication request and/or the PINE authentication response carries at least one of:
a PINE authentication indicator indicating to perform the authentication on the PINE;
a PEGC identifier indicating the PEGC, wherein the PEGC identifier includes at least one of a subscription permanent identifier (SUPI) or a subscription concealed identifier (SUCI); or
a PINE identifier indicating the PINE.

In an embodiment, the PINE authentication indicator indicates the core network device and the PINE not to perform at least one of:
generating an authentication service function key Kausf;
generating a security anchor function key Kseaf;
sending a key set identifier ngKSI to the PEGC; or
sending an anti-bidding down between architectures (ABBA) parameter to the PEGC.

In an embodiment, the EAP request further includes first indication information configured to determine a first service network name.

In an embodiment, the device further includes a processing module 320, configured to:
determine a second integrity protection key and a second confidentiality protection key at least based on the first service network name and a second credential; and
verifying the EAP request using the second integrity protection key and the second confidentiality protection key.

In an embodiment, the processing module 320 is further configured to:
in response to that verifying the EAP request fails, send verifying failure information to the core network device to stop performing the EAP-AKA′ authentication on the PINE.

In an embodiment, the transceiver module 310 is further configured to receive second indication information indicating a second service network name sent by the PEGC; and
the processing module 320 is further configured to, in response to that verifying the EAP request is successful, verify a consistency between the first service network name and the second service network name.

In an embodiment, the processing module 110, the transceiver module 120, the transceiver module 210, the transceiver module 310, the processing module 320 or the like may be implemented by one or more central processing units (CPUs), graphics processing units (GPUs), baseband processors (BPs), application specific integrated circuits (ASICs), DSPs, programmable logic devices (PLDs), complex programmable logic devices (CPLDs), field-programmable gate arrays (FPGAs), general purpose processors, controllers, micro controller units (MCU), microprocessors, or other electronic components implementation for performing the foregoing method.

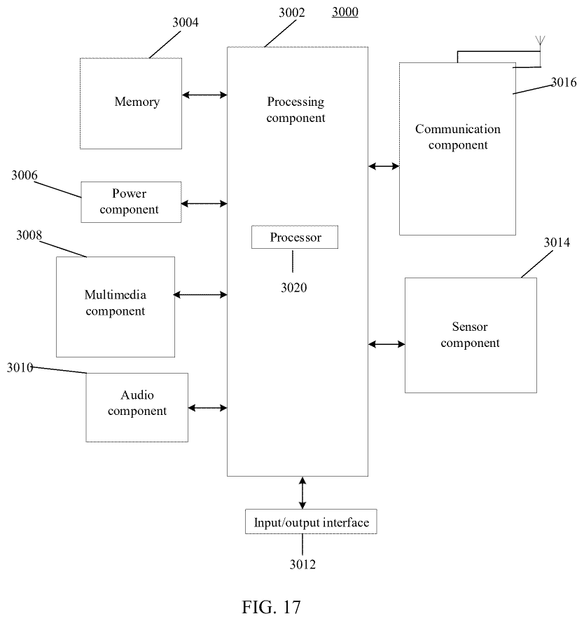

FIG. 17 is a block diagram of a device for authentication 3000 according to an embodiment. For example, the device 3000 may be a mobile phone, a computer, a digital broadcasting terminal, a messaging device, a game console, a tablet device, a medical device, a fitness device, a personal digital assistant, or the like.

Referring to FIG. 17, the device 3000 may include one or more of a processing component 3002, a memory 3004, a power component 3006, a multimedia component 3008, an audio component 3010, an input/output (I/O) interface 3012, a sensor component 3014, and a communication component 3016.

The processing component 3002 generally controls the overall operations of the device 3000, such as operations associated with display, telephone calls, data communications, camera operations, and recording operations. The processing component 3002 may include one or more processors 3020 to execute instructions to complete all or part of the steps of the foregoing method. In addition, the processing component 3002 may include one or more modules to facilitate interaction between the processing component 3002 and other components. For example, the processing component 3002 may include a multimedia module to facilitate the interaction between the multimedia component 3008 and the processing component 3002.

The memory 3004 is configured to store various types of data to support the operation at the device 3000. Examples of these data include instructions for any application or method operating on the device 3000, contact data, phone book data, messages, pictures, videos and the like. The memory 3004 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 3006 provides power to various components of the device 3000. The power component 3006 may include a power management system, one or more power supplies, and other components associated with generating, managing, and distributing power for the device 3000.

The multimedia component 3008 includes a screen that provides an output interface between the device 3000 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 3008 includes a front camera and/or a rear camera. When the device 3000 is in an operation mode, such as a shooting mode or a video mode, the front camera and/or the rear camera can receive external multimedia data. Each of the front camera and rear camera may be a fixed optical lens system or have focal length and optical zoom capabilities.

The audio component 3010 is configured to output and/or input audio signals. For example, the audio component 3010 includes a microphone (MIC), and when the device 3000 is in an operation mode, such as a call mode, a recording mode, and a voice recognition mode, the microphone is configured to receive an external audio signal. The received audio signal can be further stored in the memory 3004 or sent via the communication component 3016. In some embodiments, the audio component 3010 further includes a speaker for outputting audio signals.

The I/O interface 3012 provides an interface between the processing component 3002 and a peripheral interface module. The above-mentioned peripheral interface module may be a keyboard, a click wheel, a button, and the like. These buttons may include but are not limited to home button, volume button, start button, and lock button.

The sensor component 3014 includes one or more sensors for providing the device 3000 with various aspects of state evaluation. For example, the sensor component 3014 can detect the on/off status of the device 3000 and the relative positioning of components. For example, the component is a display and keypad of the device 3000. The sensor component 3014 can also detect the position change of the device 3000 or a component of the device 3000, the presence or absence of contact between the user and the device 3000, the orientation or acceleration/deceleration of the device 3000, and the temperature change of the device 3000. The sensor component 3014 may include a proximity sensor configured to detect the presence of nearby objects when there is no physical contact. The sensor component 3014 may also include a light sensor, such as a CMOS or CCD image sensor, for use in imaging applications. In some embodiments, the sensor component 3014 may also include an acceleration sensor, a gyroscope sensor, a magnetic sensor, a pressure sensor, or a temperature sensor.

The communication component 3016 is configured to facilitate wired or wireless communication between the device 3000 and other devices. The device 3000 can access a wireless network based on a communication standard, such as WiFi, 2G, or 3G, or a combination thereof. In an embodiment, the communication component 3016 receives a broadcast signal or broadcast related information from an external broadcast management system via a broadcast channel. In an embodiment, the communication component 3016 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the device 3000 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 3004 including instructions, and the instructions may be executed by the processor 3020 of the device 3000 to complete the foregoing method. For example, the non-transitory computer-readable storage medium may be ROM, random access memory (RAM), CD-ROM, magnetic tape, floppy disk, optical data storage device and the like.

A person skilled in the art may easily conceive of other implementations of the embodiments of the present disclosure upon consideration of the specification and practice of the invention disclosed herein. The present disclosure is intended to cover any variations, uses, or adaptations of the embodiments of the present disclosure that follow the general principles of the embodiments of the present disclosure and include the common knowledge or conventional technical means in the technical art not disclosed by the embodiments of the present disclosure. The specification and embodiments are to be regarded as exemplary only, and the true scope and spirit of the embodiments of the present disclosure is indicated by the following claims.

It is to be understood that the embodiments of the present disclosure are not limited to the precise structures described above and illustrated in the accompanying drawings, and that various modifications and changes may be made without departing from the scope thereof. The scope of the embodiments of the present disclosure is limited only by the appended claims.

1. An authentication method, which is performed by a core network device of a first class network, comprising:
performing extensible authentication protocol-authentication and key agreement′ (EAP-AKA′) authentication on a personal IoT network element (PINE), wherein the PINE is accessed to the first class network through a personal IoT network element with gateway capability (PEGC), and the PINE is connected to the PEGC through a second class network.

2. The method according to claim 1, wherein performing the EAP-AKA′ authentication on the PINE comprises:
determining an expected authentication parameter at least based on a calculating parameter and a first credential of the PINE; an
performing the EAP-AKA′ authentication on the PINE at least based on the expected authentication parameter.

3. The method according to claim 2, wherein the first credential is stored in the core network device, or is determined by the core network device based on at least one of a PINE identifier of the PINE or a PEGC identifier of the PEGC.

4. (canceled)

5. The method according to claim 2, wherein performing the EAP-AKA′ authentication on the PINE at least based on the expected authentication parameter comprises:
sending an EAP request to the PEGC via a base station by means of the first class network, wherein the EAP request at least comprises the calculating parameter, and the calculating parameter is sent through the EAP request to the PINE by means of a second class network;
receiving an EAP response sent by the PEGC via the base station by means of the first class network, wherein the EAP response at least comprises an authentication parameter, and the authentication parameter is determined by the PINE at least based on a second credential and the calculating parameter and is carried in the EAP response to be sent to the PEGC by means of the second class network; and
performing the EAP-AKA′ authentication on the PINE at least based on a comparison of the authentication parameter and the expected authentication parameter.

6. The method according to claim 5, wherein sending the EAP request to the PEGC via the base station by means of the first class network comprises at least one of:
sending, by a unified data management (UDM) in the core network device, a UDM response carrying the EAP request to an authentication service function (AUSF) in the core network device;
sending, by the AUSF, an AUSF response carrying the EAP request to a security anchor function (SEAF) in the core network device; or
sending, by the SEAF, an authentication request carrying the EAP request to the PEGC via the base station by means of the first class network, wherein the EAP request is carried in a PINE authentication request by the PEGC to be sent to the PINE,
wherein receiving the EAP response sent by the PEGC via the base station by means of the first class network comprises at least one of:
receiving, by the SEAF, an authentication response carrying the EAP response sent by the PEGC via the base station by means of the first class network, wherein the EAP response is carried in a PINE authentication response by the PINE to be sent to the PEGC by means of the second class network; or
receiving, by the AUSF, an AUSF authentication request carrying the EAP response sent by the SEAF,
wherein at least one of the UDM response, the AUSF response, the authentication request, the authentication response, the PINE authentication request, the PINE authentication response or the AUSF authentication request carries at least one of:
a PINE authentication indicator indicating to perform the EAP-AKA′ authentication on the PINE;
a PEGC identifier indicating the PEGC, wherein the PEGC identifier comprises at least one of a subscription permanent identifier (SUPI) or a subscription concealed identifier (SUCI); or
a PINE identifier indicating the PINE.

7-8. (canceled)

9. The method according to claim 6, further comprising: in response to the PINE identifier being a protected PINE identifier, restoring the protected PINE identifier to a PINE identifier in a plaintext state,
wherein at least one of the UDM response, the AUSF response, or the AUSF authentication request carries the PINE identifier in the plaintext state, and
at least one of the authentication request, the PINE authentication request, the PINE authentication response, or the authentication response carries the protected PINE identifier.

10. (canceled)

11. The method according to claim 5, wherein the authentication parameter and the expected authentication parameter are identified using at least one of:
a PINE identifier of the PINE; or
a PEGC identifier of the PEGC.

12. The method according to claim 5, further comprising:
determining a first integrity protection key and a first confidentiality protection key at least based on a first service network name and the first credential of the PINE,
wherein the EAP request is protected by the first integrity protection key and the first confidentiality protection key,
wherein the EAP request further comprises first indication information configured to determine the first service network name.

13. (canceled)

14. The method according to claim 2, further comprising: determining, based on judging information, whether the PEGC is a legitimate gateway for the PEGC to access the first class network, wherein the judging information comprises at least one of:
a PEGC identifier of the PEGC;
a PINE identifier of the PINE; or
subscription information of the PEGC, and
wherein determining the expected authentication parameter at least based on the calculating parameter and the first credential of the PINE comprises:
determining the PEGC as the legitimate gateway; and
determining the expected authentication parameters based on the calculating parameter and the first credential of the PINE.

15-16. (canceled)

17. An authentication method, which is performed by a personal IoT network element with gateway capability (PEGC), comprising:
communicating authentication information during a core network device of a first class network performing extensible authentication protocol-authentication and key agreement′ (EAP-AKA′) authentication on a personal IoT network element (PINE), wherein the PINE is accessed to the first class network through the PEGC, and the PINE is connected to the PEGC through a second class network.

18. The method according to claim 17, wherein communicating the authentication information during the core network device of the first class network performing the EAP-AKA′ authentication on the PINE comprises:
receiving an EAP request carrying a calculating parameter sent by the core network device to the PEGC via a base station by means of the first class network, wherein the calculating parameter is configured for the core network device to determine an expected authentication parameter at least in conjunction with a first credential, and the expected authentication parameter is configured for the core network device to perform the authentication on the PINE;
sending the EAP request carrying the calculating parameter to the PINE by means of the second class network;
receiving an EAP response carrying an authentication parameter sent by the PINE by means of the second class network, wherein the authentication parameter is determined by the PINE at least based on a second credential and the calculating parameter; and
sending the EAP response carrying the authentication parameter to the core network device via the base station by means of the first class network, wherein the authentication parameter is configured for the core network device to perform the authentication on the PINE at least based on the expected authentication parameter.

19-20. (canceled)

21. The method according to claim 18, wherein receiving the EAP request carrying the calculating parameter sent by the core network device to the PEGC via the base station by means of the first class network comprises:
receiving an authentication request carrying the EAP request sent by an SEAF in the core network device via the base station by means of the first class network,
sending the EAP request carrying the calculating parameter to the PINE by means of the second class network comprises:
sending a PINE authentication request carrying the EAP request to the PINE by means of the second class network,
receiving the EAP response carrying the authentication parameter sent by the PINE by means of the second class network comprises:
receiving a PINE authentication response carrying the EAP response sent by the PINE by means of the second class network, and
sending the EAP response carrying the authentication parameter to the core network device via the base station by means of the first class network comprises:
sending an authentication response carrying the EAP response to the SEAF via the base station by means of the first class network,
wherein at least one of the authentication request, the authentication response, the PINE authentication request or the PINE authentication response carries at least one of:
a PINE authentication indicator indicating to perform the authentication on the PINE;
a PEGC identifier indicating the PEGC, wherein the PEGC identifier comprises at least one of a subscription permanent identifier (SUPI) or a subscription concealed identifier (SUCI); or
a PINE identifier indicating the PINE.

22-24. (canceled)

25. The method according to claim 18, further comprising:
sending second indication information indicating a second service network name to the PINE.

26. An authentication method, which is performed by a personal IoT network element (PINE), comprising:
communicating authentication information during a core network device of a first class network performing extensible authentication protocol-authentication and key agreement′ (EAP-AKA′) authentication on the PINE, wherein the PINE is accessed to the first class network through a personal IoT network element with gateway capability (PEGC), and the PINE is connected to the PEGC through a second class network.

27. The method according to claim 26, wherein communicating the authentication information during the core network device of the first class network performing the EAP-AKA′ authentication on the PINE comprises:
receiving an EAP request carrying a calculating parameter sent by the PEGC by means of the second class network, wherein the EAP request is sent by the core network device to the PEGC via a base station by means of the first class network, the calculating parameter is configured for the core network device to determine an expected authentication parameter at least in conjunction with a first credential, and the expected authentication parameter is configured for the core network device to perform the authentication on the PINE.

28. (canceled)

29. The method according to claim 27, further comprising: determining an authentication parameter at least based on a second credential and the calculating parameter,
wherein communicating the authentication information during the core network device of the first class network performing the authentication on the PINE comprises:
sending an EAP response carrying the authentication parameter to the PEGC by means of the second class network, the EAP response being sent to the core network device by the PEGC via the base station by means of the first class network and configured for the core network device to perform the authentication on the PINE at least based on the authentication parameter and the expected authentication parameter.

30. The method according to claim 29, wherein
receiving the EAP request carrying the calculating parameter sent by the PEGC by means of the second class network comprises:
receiving a PINE authentication request carrying the EAP request sent by the PEGC by means of the second class network, and
sending the EAP response carrying the authentication parameter to the PEGC by means of the second class network comprises:
sending a PINE authentication response carrying the EAP response to the PEGC by means of the second class network,
at least one of the PINE authentication request or the PINE authentication response carries at least one of:
a PINE authentication indicator indicating to perform the authentication on the PINE;
a PEGC identifier indicating the PEGC, wherein the PEGC identifier comprises at least one of a subscription permanent identifier (SUPI) or a subscription concealed identifier (SUCI); or
a PINE identifier indicating the PINE.

31-32. (canceled)

33. The method according to claim 27, wherein the EAP request further comprises first indication information configured to determine a first service network name,
wherein the method further comprises:
determining a second integrity protection key and a second confidentiality protection key at least based on the first service network name and a second credential; and
verifying the EAP request using the second integrity protection key and the second confidentiality protection key.

34. (canceled)

35. The method according to claim 33, further comprising:
in response to that verifying the EAP request fails, sending verifying failure information to the core network device to stop performing the EAP-AKA′ authentication on the PINE.

36. The method according to claim 33, further comprising:
receiving second indication information indicating a second service network name sent by the PEGC; and
in response to that verifying the EAP request is successful, verifying a consistency between the first service network name and the second service network name.

37-41. (canceled)
